(19) United States
(12) Patent Application Publication
(10) Pub. No.: US 2017/0337650 A1
(43) Pub. Date: Nov. 23, 2017

(54) INTELLECTUAL-PROPERTY ASSEMBLY LINE SYSTEMATIZES COMPONENTS, ORDEREDLY NUMBERS COMPONENTS, CATEGORIZES COMPONENTS, SYNCHRONIZING COMPONENTS, FORMULATES INVENTION SPECIFICATIONS, AND SIMPLIFIES INVENTION SPECIFICATIONS TO THE SIMPLEST DESCRIPTIVE LEVEL

(71) Applicant: DEE VOLIN, FAIRVIEW, OR (US)

(72) Inventor: DEE VOLIN, FAIRVIEW, OR (US)

(21) Appl. No.: 15/597,152

(22) Filed: May 17, 2017

Related U.S. Application Data
(60) Provisional application No. 62/339,029, filed on May 19, 2016.

(51) Int. Cl. G06Q 50/18; G06F 17/21; G06F 17/30

(52) U.S. Cl. CPC G06Q 50/184; G06F 17/30392; G06F 17/214; G06F 17/30011

(57) ABSTRACT

A unique system comprises twenty simplest-descriptive-level formulas, at least one mobile or stationary device, and at least one operating and/or applicational software downloaded to the at least one mobile or stationary device for operating the at least one mobile or stationary device. The unique system is for helping a user be able to quickly and easily describe, preserve, retrieve, process, and benefit from inventions. Each of the twenty simplest-descriptive-level formulas is for describing only one aspect of each component of an invention, at the simplest descriptive level such that the related components in each component aspect of the invention are systematized (grouped into systems), and such that the alphanumeric prefix and the alphanumeric suffix of each component in each component aspect match each other and increase sequentially. The twenty simplest-descriptive-level formulas systematize, orderedly number, categorize, synchronize, standardize, and simplify each component description in each component aspect of an invention to the simplest descriptive level.

### 1. FIELD OF THE INVENTION

The present invention relates to an invention-describing method for describing an invention. Particularly, the present invention relates to a unique system of 20 simplest-descriptive-level formulas, which:
1) Groups related components into systems in each component aspect to quickly and easily understand the components
   (systematizes components in each component aspect);
2) Sequentially numbers components in each component aspect to quickly and easily understand the components
   (orderedly numbers components in each component aspect);
3) Sectionizes components in each component aspect to quickly and easily find the components
   (categorizes components in each component aspect);
4) Matches component prefixes and suffixes in each component aspect to quickly and easily find the components)
   (synchronizes prefixes and suffixes in each component aspect);
5) Standardizes component descriptions in each component aspect to quickly and easily describe the components
   (formulates component descriptions in each component aspect); and
6) Simplifies components descriptions in each component aspect to the simplest descriptive level to quickly and easily describe the components
   (simplifies component descriptions in each component aspect).

### 2. DESCRIPTION OF THE PRIOR ART

A number of describing methods have been introduced.

U.S. Pat. No. 5,754,840, issued 1998 May 19, to Kevin G. Rivette, describes a system and method for assisting in document preparation and analysis, such as a patent application. The system aids a user to verify that terms in a patent application are being used consistently and facilitates editing to achieve terminology consistency.

U.S. Pat. No. 5,774,833, issued 1998 Jun. 30, to Marc Alan Newman, describes a method for processing patent text in a computer including identifying boundaries of parts of patent text, loading at least one of the parts of the patent text into a working memory, analyzing at least one of the parts of the patent text, and reporting results to a user. Alphanumeric drawing data can also be compared to patent text.

U.S. Pat. No. 6,049,811 issued 2000 Apr. 11, to James D. Petruzzi, describes a machine and method for drafting a patent application which has a computer for receiving and transmitting data. The computer requests and stores information regarding the invention including: 1) qualities and benefits (QAB); 2) primary elements (PE); 3) secondary elements (SE); and 4) substitute elements (SUB). The sections are drafted in a predetermined order prohibiting jumping ahead to draft a later section. At many sections, initial draft text, examples, samples, legal material, etc. are available to the user. A final patent application is compiled by combining the drafted sections with predetermined text.

U.S. Pat. No. 6,298,327 issued 2001 Oct. 2, to Robert M. Hunter, describes a computer-implemented expert support system for authoring invention disclosures and for evaluating the probable patentability and marketability of a disclosed invention. The system comprises at least a computer, an input device, an output device, and software program. The software program has an object-oriented design process and is implemented in an object-oriented computer language. The system facilitates communication of invention characteristics and enables output of invention disclosures in a plurality of formats, including that of a patent application.

U.S. Pat. No. 6,499,026 issued 2002 Dec. 24, to Kevin G. Rivette visualizes a system, method, and computer program product for processing data. The system maintains first databases of patents, and second databases of non-patent information of interest to a corporate entity. The processing automatically performed by the system relates to (but is not limited to) patent mapping, document mapping, patent citation (both forward and backward), patent aging, patent bracketing/clustering (both forward and backward), inventor patent count, inventor employment information, patent claim tree analysis, and finance.

U.S. Pat. No. 6,574,645 issued 2003 Jun. 3, to James D. Petruzzeach describes a machine and method for drafting a patent application which has a computer for receiving and transmitting data. The computer requests and stores information regarding the invention including: 1) qualities and benefits (QAB); 2) primary elements (PE); 3) secondary elements (SE); and 4) substitute elements (SUB). The sections are drafted in a predetermined order prohibiting jumping ahead to draft a later section. At many sections, initial draft text, examples, samples, legal material, etc. are available to the user. A final patent application is compiled by combining the drafted sections with predetermined text.

U.S. Pat. No. 6,662,178 issued 2003 Dec. 9, to Eugene M. Lee, provides an apparatus for and a method of searching and organizing intellectual property (IP). In an exemplary embodiment, a search and organization server is provided with an IP thesaurus module for developing a list of elements that may be used as an aid in learning a new technology, as a search tool to refine search queries or criteria, as a drafting tool to assist in the preparation of technical or legal documents (e.g., proposals, licenses, patent applications, etc.), or any other practical use.

U.S. Pat. No. 6,694,331 issued 2004 Feb. 17, to Eugene M. Lee, discloses an apparatus and method of searching and organizing intellectual property. In accordance with a preferred embodiment of the invention, an apparatus (and corresponding method) is provided for formulating and facilitating searches for intellectual property, and organizing results of such searches. In an exemplary embodiment, a search and organization server is provided with one or more modules to create and process search queries to be run on local or remote database systems.

U.S. Pat. No. 7,890,851 issued 2011 Feb. 15, to Harold W. Milton, Jr., discloses a computer program for drafting a patent application including a template memory for storing and duplicating standard headings and paragraphs and which interacts with other memories and processors to provide a structure and process to follow in preparing a patent application.

U.S. Pat. No. 7,996,767 issued 2011 Aug. 9, to Chung-I Lee, discloses systems and methods of generating electronic patent application files, which includes steps of: creating multiple extensible markup language templates; setting basic requirements of drafted files; mapping the templates to chapter headers in the drafted files; analyzing if the drafted files meet the basic requirements; parsing contents of the drafted files into corresponding templates; and generating patent application files according to templates.

U.S. Pat. No. 8,229,871 issued 2012 Jun. 24, to Tod M. Woolf, discloses a systematic approach to computer aided inventing. A model representing any item, composition or process can be defined and configured using the lexicon and specification of an innovation database. In the model, objects can be identified, defined, and configured to provide the model with constituent products, components, features and materials. An innovation engine applies morphs from the innovation database to the objects of the model to generate morphed versions of the model that may provide innovations of or invention to the item, composition or process represented by the model.

U.S. Pat. No. 8,612,853 issued 2013 Dec. 17, to Harold W. Milton, Jr., discloses a system for preparing a patent application in conjunction with a word processing program. The patent application includes elements, each having a common noun and being differentiated by a different adjective or combination of adjectives. The computer program automatically inserts the proper reference numeral or reference numerals following each occurrence of the common noun throughout the patent application.

U.S. Pat. No. 9,542,360 issued 2017 Jan. 10, to Bao Tran, discloses systems and methods to analyze a patent document by identifying at least one element and relationship to other element(s) in a figure; analyzing text description of the element and relationship to other element(s); generating a user manipulable claim data structure including elements in a potential claim; and displaying a relationship between claims and showing the claims as one or more text nodes.

U.S. Publication No 20020072920 published 2002 Jun. 13, to Jeffry Grainger, describes a computer implemented method of generating invention disclosure statements. The method reduces the likelihood that a known prior art reference document will erroneously go undisclosed to a patent office by an individual who files the patent applications. Additionally, the method of the present invention simplifies and streamlines the tasks that must be carried out in order to comply with the various disclosure requirements of patent offices around the world.

U.S. Publication No 20040059994 published 2004 Mar. 25, to Ronny Fogel, demonstrates a method for checking semantic and syntactical correctness of patent claims. The method first checks for sequential claims numbering. For each claim a type and dependency are determined and the dependencies are checked for type match. Each claim is then parsed and checked for syntactical correctness and for correct antecedent basis for all its terms.

U.S. Publication No 20040168129 published 2004 Aug. 26, to G. Michael Roebuck, enables one or a plurality of inventors to enter invention disclosures comprising figures and descriptive text along with patent application support documentation required by the United States Patent Office (USPTO) such as transmittal forms, fee sheets, inventor declarations and assignments into a central document for filing as a patent application.

U.S. Publication No 20040205599 published 2004 Oct. 14, to Whewell, Jean E., provides patentability search reports which include a listing of prior art for a proposed invention, statements of differences between features of the proposed invention and those in the prior art and a draft patent claim, preferably drafted by a patent Practitioner. Using the draft claim, it is possible for the writer to make a mock rejection(s) of the draft claim, including suggested means for obviating such mock rejections.

U.S. Publication No 20060059413 published 2006 Mar. 16, to Bao Q. Tran, discloses systems and methods for checking a document by identifying all nouns in a portion of the document; and checking that the first occurrence of each noun or noun phrases has proper antecedent basis. The techniques provide an easy-to-use patent generating system for patent applicants to learn and use. The software provides visually based tools to create an intuitive environment in which a patent application may be developed.

U.S. Publication No 20070136321 published 2007 Jun. 14, to Jacob Allen, describes a method of preparing a patent application by running a software macro to present a Tool bar to display options of Setup for document information and Number Claims for numbering the claims and Build Description for duplicating the claims into the description section and Build Intro Sections for dividing and duplicating selected claims into the introductory sections as well as Build Abstract and Count Abstract and Format and Mark Element for assigning a reference numeral and Element List and Number patent for automatically displaying the reference numerals.

U.S. Publication No 20070220041 published 2007 Sep. 20, to Andrew S. Van Luchene, describes methods for drafting, preparing, submitting and examining a patent application. The system incorporates a web-based tool in which applications are drafted. The web-based tool further allows for the submission, association, and display of notes regarding applications. The notes may be text or hyperlinks to prior art references. The relevance of the prior art documents to the patent application may be indicated by visible indicia.

U.S. Publication No 20130086046 published 2013 Apr. 4, to Steven W. Lundberg, presents a system and computer implemented method of maintaining a database of patent portfolios, for association with a database of patents. The method includes receiving a search query associated with a first patent portfolio; searching the first portfolio; generating a seed set of search results including one or more patent claims, including terms from the search query; automatically generating an expanded set of search results including one or more patent claims further associated with the search query or associated with the patent claims in the seed set of search results; and mapping the one or more patent claims to a patent concept.

U.S. Publication No 20130317994 published 2013 Nov. 28, to Bao Tran, presents systems and methods to generate a patent application by receiving and locating key concepts in an invention disclosure; searching for patent references of interest; displaying sample patent references; receiving drawings generated by a camera, a diagramming tool, a drawing tool, a presentation tool, and a word document editor; annotating the drawings with reference numerals and pointer lines; generating text for each drawing; diagnosing text to comply with formality requirements; and generating the patent application.

U.S. Publication No 20160048936 published 2016 Feb. 18, to Thomas J. Perkowski, presents an advanced relational database and user interface system used for the evaluation, analysis and generation of specialized reports in any of a plurality data analysis environments. The database and analysis system can be utilized for many purposes, but particularly and preferably to support the analysis of patent claims and more specifically claim construction, infringement, written description, invalidity and/or patentability, among other matters of intellectual property litigation and analyses.

### DISADVANTAGES OF THE PRIOR ART

It is impossible for the prior art to perform the 28 HIGHLY BENEFICIAL FUNCTIONS, all of which the present invention can efficiently perform. When using the prior-art methods to search for each dada of each component, computers and people have to search the ENTIRE SPECIFICATION.

### 1) Referring to FIG. 7 (Prior Art):

By using the prior-art methods, from looking at the reference numbers of components in the DRAWINGS or TEXTS displayed on a monitor of a mobile or stationary computer (for example, reference number 37 in FIG. 7 (Prior Art), it is impossible to know WHERE each and every data of each and every component in each and every component aspect are stored in a computer memory to find and retrieve each and every data of each and every component in each and every component aspect (for example, material aspect, shape aspect, connection aspect, function aspect, etc.). Therefore, by using the prior-art methods, computers and people have to search the ENTIRE SPECIFICATION to find each data of each component.

Therefore, by using the prior-art methods, computers and people have to spend a lot of time to search the ENTIRE SPECIFICATION, character by character, word by word, phrase by phrase, line by line, paragraph by paragraph, page after page, number in each phrase by number in each phrase, number in each line by number in each line, number in each paragraph by number in each paragraph, number on each page by number on each page, and so on. Imagine the time it takes to find and retrieve all the data of each of 2,000 components in all component aspects of an invention of a car engine. Therefore, the prior-art methods are VERY INEFFICIENT and VERY TIME-CONSUMING for computers, inventors, USTPO examiners, patent lawyers, scientists, educators, engineers, manufacturers, educators, students, and people from all walks of life to use.

### 2) Referring to FIG. 7 (Prior Art):

By using the prior-art methods, from looking at the reference numbers of components in the DRAWINGS or TEXTS displayed on a monitor of a mobile or stationary computer (for example, reference number 37 in FIG. 7 (Prior Art):
a) It is impossible to know WHERE the material description of a component is stored in a computer memory,
b) It is impossible to know WHERE the shape description of a component is stored in a computer memory,
c) It is impossible to know WHERE the connection description of a component is stored in a computer memory,
d) It is impossible to know WHERE the function description of a component is stored in a computer memory.

Therefore, by using the prior-art methods, computers and people have to search the ENTIRE SPECIFICATION to find each data of each component.

Therefore, by using the prior-art methods, computers and people have to spend a lot of time to search the ENTIRE SPECIFICATION, character by character, word by word, phrase by phrase, line by line, paragraph by paragraph, page after page, number in each phrase by number in each phrase, number in each line by number in each line, number in each paragraph by number in each paragraph, number on each page by number on each page, and so on. Imagine the time it takes to find and retrieve all the data of each of 2,000 components in all component aspects of an invention of a truck engine. Therefore, the prior-art methods are VERY INEFFICIENT and VERY TIME-CONSUMING for computers, inventors, USTPO examiners, patent lawyers, scientists, educators, engineers, manufacturers, educators, students, and people from all walks of life to use.

### 3) Referring to FIG. 8 (Prior Art):

With the prior-art methods, by looking at the DRAWINGS or TEXTS displayed on a monitor of a mobile or stationary computer (for example, reference number 53 in FIG. 8 (Prior Art), it is impossible to know WHERE each and every data of each and every component in each and every component aspect are stored in a computer memory (or is described in the specification) to find and retrieve each and every data of each and every component in each and every component aspect (for example, material aspect, shape aspect, connection aspect, function aspect, etc.).

Therefore, by using the prior-art methods, computers and people have to spend a lot of time to search the ENTIRE SPECIFICATION, character by character, word by word, phrase by phrase, line by line, paragraph by paragraph, page after page, number in each phrase by number in each phrase, number in each line by number in each line, number in each paragraph by number in each paragraph, number on each page by number on each page, and so on. Imagine the time it takes to find and retrieve all the data of each of 2,000 components in all component aspects of an invention of a semi-truck engine. Therefore, the prior-art methods are VERY INEFFICIENT and VERY TIME-CONSUMING for computers, inventors, USTPO examiners, patent lawyers, scientists, educators, engineers, manufacturers, educators, students, and people from all walks of life to use.

### 4) Referring to FIG. 8 (Prior Art):

With the prior-art methods, by looking at the DRAWINGS or TEXTS displayed on a monitor of a mobile or stationary computer (for example, all the questions in FIG. 8 (Prior Art), it is impossible to know WHERE each and every data of each and every component in each and every component aspect are stored in a computer memory (or is described in the specification) to find and retrieve each and every data of each and every component in each and every component aspect (for example, material aspect, shape aspect, connection aspect, function aspect, etc.).

Therefore, by using the prior-art method, computers and people have to spend a lot of time to search the ENTIRE SPECIFICATION, character by character, word by word, phrase by phrase, line by line, paragraph by paragraph, page after page, number in each phrase by number in each phrase, number in each line by number in each line, number in each paragraph by number in each paragraph, number on each page by number on each page, and so on. Imagine the time it takes to find and retrieve all the data of each of 2,000 components of an invention of a ship engine. Therefore, the prior-art methods are VERY INEFFICIENT and VERY TIME-CONSUMING for computers, inventors, USTPO examiners, patent lawyers, scientists, educators, engineers, manufacturers, educators, students, and people from all walks of life to use.

### 28 Highly Beneficial Functions the Present Invention can Efficiently Perform (which is Impossible for the Prior Art to do)

The present invention helps computers and people quickly and easily find, go straight to, retrieve, transmit, share, store, process, file, etc. each and every data of each and every component in each and every component aspect (for example, material aspect, shape aspect, connection aspect, function aspect, etc.) displayed on a computer monitor or stored in a computer memory (which is impossible for the prior art to do).

The present invention helps computers and people quickly and easily MATCH the sequential PREFIX and the sequential SUFFIX of each and every component name with each other in each and every component aspect (for example, material aspect, shape aspect, connection aspect, function aspect, etc.) to KNOW EXACTLY WHERE each and every data of each and every component in each and every component aspect are displayed on a computer monitor, is described in a specification, or are stored in a computer memory to help computers and people quickly and easily find, go straight to, retrieve, transmit, share, store, process, file, etc. each and every data of each and every component in each and every component aspect displayed on a computer monitor, described in a specification, or stored in a computer memory (which is impossible for the prior art to do).

Referring to FIG. 4 and the FOURTH EXAMPLE in the ensuing specification, the present invention provides the following method:
1) Creating a component list of an invention;
   (For example, see the COMPONENT list in the FOURTH EXAMPLE in the ensuing specification)
2) Systematizing related components into SYSTEMS in the component list
   to create a systematized-component list,
   to specify HOW MANY SYSTEMS the invention comprises, and
   to specify WHAT SYSTEM each component belongs to
   (For example, in the COMPONENT list in the FOURTH EXAMPLE in the ensuing specification, the components are grouped into four SYSTEMS, as follows:
      A sole system 101,
      A protecting system 106,
      A lace system 113, and
      Multiple eyelet systems 116)
3) Adding reference numbers to components in the systematized-component list;
   (For example, see the COMPONENT list in the FOURTH EXAMPLE in the ensuing specification)
4) Adding a sequential PREFIX to each component;
   (For example, in the COMPONENT list in the FOURTH EXAMPLE in the ensuing specification, each sequential PREFIX (1, 2, 3, 4, 5) is the FIRST character in each line of each component, as follows:
      1) A sole system 101,
      2) A front sole 102,
      3) A rear sole 103,
      4) A traction pad 104,
      5) Glue 105)
5) Adding a sequential SUFFIX to the reference number of each component such that the sequential PREFIX and the sequential SUFFIX of each component MATCH EACH OTHER and increase sequentially;
   (For example, in the COMPONENT list in the FOURTH EXAMPLE in the ensuing specification, each sequential SUFFIX (1, 2, 3, 4, 5) is the LAST character in each reference number of each component, as follows:
      1) A sole system 101,
      2) A front sole 102,
      3) A rear sole 103,
      4) A traction pad 104,
      5) Glue 105.
   The sequential PREFIX and SUFFIX of each name match each other)
6) Creating at least one component aspect
   (e.g., material aspect, shape aspect, connection aspect, function aspect);
   (For example, in the FOURTH EXAMPLE in the ensuing specification, the MATERIAL, SHAPE, CONNECTION, FUNCTION aspects are created)
7) Using the SAME systematized-component list with the matching sequential PREFIXES and SUFFIXES in each of the at least one component aspect (e.g., material aspect, shape aspect, connection aspect, function aspect);
   (For example, in the FOURTH EXAMPLE in the ensuing specification, the SAME systematized-component list with the matching sequential PREFIXES and SUFFIXES are used in the MATERIAL, SHAPE, CONNECTION, FUNCTION aspects)
8) Describing each of the at least one component aspect by using at least one of the 20 simplest-descriptive-level formulas of the present invention.
   (For example, in the FOURTH EXAMPLE in the ensuing specification, the MATERIAL, SHAPE, CONNECTION, FUNCTION aspects are described with at least one of the 20 simplest-descriptive-level formulas)

By using the SAME systematized-component list with the matching sequential PREFIXES and SUFFIXES in each and every component aspect, it GREATLY REDUCES THE PROCESSING TIMES by allowing computers and people to QUICKLY AND EASILY MATCH the sequential PREFIX with the sequential SUFFIX of each and every component in each and every component aspect (for example, material aspect, shape aspect, connection aspect, function aspect) to QUICKLY AND EASILY FIND, RETRIEVE, TRANSMIT, SHARE, STORE, PROCESS, EMAIL, FILE each and every data of each and every component in each and every component aspect displayed on a computer monitor, described in a specification, or stored in a computer memory in DRAWINGS or TEXTS (which is impossible for the prior art to do).

As the results of all the above, the present invention:
a) Greatly improves the processing functioning of mobile computers,
b) Greatly improves the processing functioning of stationary computers,
c) Greatly improves multiple processing aspects of intellectual technologies,
d) Greatly benefits mobile computers, stationary computers, inventors, USTPO examiners, patent lawyers, scientists, educators, engineers, manufacturers, educators, students, people, etc., and
e) Saves large amounts of time when computers or people search for patents and inventions, retrieve patents and inventions, reference patents and inventions, analyze patents and inventions, study patents and inventions, invent inventions, describe inventions, draw inventions, record inventions, store inventions, transmit inventions, share inventions, email inventions, file inventions, etc.
   (It's impossible for the prior art to perform the above functions).

### The Present Invention Greatly Reduces the Processing Times to Find and Retrieve Data (which is Impossible for the Prior Art to do)

From all DRAWINGS or TEXTS, the present invention helps computers and people greatly reduce the processing times to find, retrieve, transmit, share, store, process, email, file, etc. each and every data of each and every component in each and every component aspect (for example, material aspect, shape aspect, connection aspect, function aspect, etc.).

Referring to FIGS. 4, 5, THIRD EXAMPLE, and FOURTH EXAMPLE in the specification:

For example, by simply looking at the sequential PREFIX or the sequential SUFFIX of a component in DRAWINGS or TEXTS on a computer monitor, because the sequential PREFIX is the FIRST character of a component name and the sequential SUFFIX is the LAST character of a component name in EACH line in EACH component aspect, it GREATLY REDUCES THE PROCESSING TIMES for computers and people to QUICKLY AND EASILY MATCH the sequential PREFIX with the sequential SUFFIX (in DRAWINGS or TEXTS and in EACH line in EACH component aspect) to quickly and easily find, go straight to, retrieve, transmit, share, store, process, calculate, email, file, etc. each and every data of each and every component in each and every component aspect (for example, material aspect, shape aspect, connection aspect, function aspect, etc.) stored in a computer memory or displayed on a computer monitor (which is impossible for the prior art to do).

### 12 Highly Beneficial Functions the Present Invention can Efficiently Perform (which is Impossible for the Prior Art to do)

The present invention performs the following 12 highly beneficial functions and offers multiple unobvious results and unobvious advantages to computers, inventors, USTPO examiners, patent lawyers, scientists, educators, engineers, manufacturers, educators, students, people, to quickly and easily find, go straight to, retrieve, transmit, share, store, process, email, file, etc. each and every data of each and every component in each and every component aspect displayed on a computer monitor or stored in a computer memory, (WHICH IS IMPOSSIBLE FOR THE PRIOR ART TO DO):
1) The present invention helps computers and people quickly and easily MATCH the sequential SUFFIX of each and every component in all DRAWINGS with its sequential PREFIX described in each and every component SYSTEM,
2) The present invention helps computers and people quickly and easily MATCH the sequential SUFFIX of each and every component in all TEXTS with its sequential PREFIX described in each and every component SYSTEM,
3) The present invention helps computers and people quickly and easily MATCH the sequential SUFFIX of each and every component in all DRAWINGS with its sequential PREFIX described in each and every component ASPECT,
4) The present invention helps computers and people quickly and easily MATCH the sequential SUFFIX of each and every component in all TEXTS with its sequential PREFIX described in each and every component ASPECT,
5) The present invention helps computers and people quickly and easily MATCH the sequential SUFFIX with the sequential PREFIX of each and every component stored in computer MEMORY,
6) The present invention helps computers and people quickly and easily FIND each and every data of each and every component in each and every component aspect stored in computer memory (by MATCHING the sequential SUFFIX and the sequential PREFIX of each and every component with each other),
7) The present invention helps computers and people quickly and easily RETRIEVE each and every data of each and every component in each and every component aspect stored in computer memory (by MATCHING the sequential SUFFIX and the sequential PREFIX of each and every component with each other),
8) The present invention helps computers and people quickly and easily PROCESS each and every data of each and every component in each and every component aspect stored in computer memory (by MATCHING the sequential SUFFIX and the sequential PREFIX of each and every component with each other),
9) The present invention helps computers and people quickly and easily TRANSMIT each and every data of each and every component in each and every component aspect stored in computer memory (by MATCHING the sequential SUFFIX and the sequential PREFIX of each and every component with each other),
10) The present invention helps computers and people quickly and easily SHARE each and every data of each and every component in each and every component aspect stored in computer memory (by MATCHING the sequential SUFFIX and the sequential PREFIX of each and every component with each other),
11) The present invention helps computers and people quickly and easily EMAIL each and every data of each and every component in each and every component aspect stored in computer memory (by MATCHING the sequential SUFFIX and the sequential PREFIX of each and every component with each other),
12) The present invention helps computers and people quickly and easily FILE each and every data of each and every component in each and every component aspect stored in computer memory (by MATCHING the sequential SUFFIX and the sequential PREFIX of each and every component with each other).

### 16 Highly Beneficial Functions the Present Invention can Efficiently Perform (which is Impossible for the Prior Art to do)

The present invention can perform the following 16 highly beneficial functions and benefits (which are impossible for the prior art to do):
1) Highly increasing the processing efficiency of mobile computers
   (e.g., smart phones, tablets, laptops, etc.) (for computers, inventors, USTPO examiners, patent lawyers, scientists, educators, engineers, manufacturers, educators, students, people, etc.);
2) Highly increasing the processing efficiency of stationary computers
   (e.g., desktop or mainframe computers, etc.) (for computers, inventors, USTPO examiners, patent lawyers, scientists, educators, engineers, manufacturers, educators, students, people, etc.);
3) Saving large amounts of time when searching for patents and inventions
   (for computers, inventors, USTPO examiners, patent lawyers, scientists, educators, engineers, manufacturers, educators, students, people, etc.);
4) Saving large amounts of time when referencing patents and inventions
   (for computers, inventors, USTPO examiners, patent lawyers, scientists, educators, engineers, manufacturers, educators, students, people, etc.);
5) Saving large amounts of time when analyzing patents and inventions
   (for computers, inventors, USTPO examiners, patent lawyers, scientists, educators, engineers, manufacturers, educators, students, people, etc.);
6) Saving large amounts of time when studying patents and inventions
   (for computers, inventors, USTPO examiners, patent lawyers, scientists, educators, engineers, manufacturers, educators, students, people, etc.);
7) Saving large amounts of time when inventing patents and inventions
   (for computers, inventors, USTPO examiners, patent lawyers, scientists, educators, engineers, manufacturers, educators, students, people, etc.);
8) Saving large amounts of time when describing patents and inventions
   (for computers, inventors, USTPO examiners, patent lawyers, scientists, educators, engineers, manufacturers, educators, students, people, etc.);
9) Saving large amounts of time when drawing patents and inventions
   (for computers, inventors, USTPO examiners, patent lawyers, scientists, educators, engineers, manufacturers, educators, students, people, etc.);
10) Saving large amounts of time when recording patents and inventions
   (for computers, inventors, USTPO examiners, patent lawyers, scientists, educators, engineers, manufacturers, educators, students, people, etc.);
11) Saving large amounts of time when storing patents and inventions
   (for computers, inventors, USTPO examiners, patent lawyers, scientists, educators, engineers, manufacturers, educators, students, people, etc.);
12) Saving large amounts of time when transmitting patents and inventions
   (for computers, inventors, USTPO examiners, patent lawyers, scientists, educators, engineers, manufacturers, educators, students, people, etc.);
13) Saving large amounts of time when sharing patents and inventions
   (for computers, inventors, USTPO examiners, patent lawyers, scientists, educators, engineers, manufacturers, educators, students, people, etc.);
14) Saving large amounts of time when emailing patents and inventions
   (for computers, inventors, USTPO examiners, patent lawyers, scientists, educators, engineers, manufacturers, educators, students, people, etc.);
15) Saving large amounts of time when filing patents and inventions
   (for computers, inventors, USTPO examiners, patent lawyers, scientists, educators, engineers, manufacturers, educators, students, people, etc.).
16) Saving large amounts of time when paying for patents and inventions
   (for computers, inventors, USTPO examiners, patent lawyers, scientists, educators, engineers, manufacturers, educators, students, people, etc.).

### Objects and Advantages of the Invention

As a result of all 60 following important advantages, the unique system will advance the economy, significantly. The unique system:
1) Groups related components together into systems in each component aspect to quickly and easily understand the components
   (systematizes components in each component aspect);
2) Sequentially numbers components in each component aspect to quickly and easily understand the components
   (orderedly numbers components in each component aspect);
3) Sectionizes components in each component aspect to quickly and easily find the components
   (categorizes components in each component aspect);
4) Matches component prefixes and suffixes in each component aspect to quickly and easily find the components)
   (synchronizes prefixes and suffixes in each component aspect);
5) Standardizes component descriptions in each component aspect to quickly and easily describe the components
   (formulates component descriptions in each component aspect); and
6) Simplifies components descriptions in each component aspect to the simplest descriptive level to quickly and easily describe the components
   (simplifies component descriptions in each component aspect).

### The 20 Simplest-Descriptive-Level Formulas Will Open the Flood Gates of Millions of New Inventions, and Will Advance the Economy

### The 20 Simplest-Descriptive-Level Formulas Will Also Help Inventors Maximize their Inventive Capabilities, and Protect all their Inventions in Confidentiality

1) The unique system systematizes (groups together and untangles) all related components of each invention into systems.
   (An invention can comprise at least one system.
   Each of the at least one system can comprise at least one component).
   (This means an invention can comprise at least one component).
   This systematizing formula allows an unlimited number of components of each invention
   (for example, an invention can comprises 10 or 10,000 components) to be quickly and easily described, searched for, preferred to, understood, benefited from, made, used, distributed, sold, etc.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
2) The unique system orderedly numbers (sequentially numbers and untangles all components and systems of each invention.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
3) The unique system categorizes (sectionizes and untangles) all components and systems of each invention
   (such that all components and systems of each invention work together as one single system of 20 simplest, easy-to-understand, organized, systematized, categorized, orderedly numbered, untangling, and simplifying formulas.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
4) The unique system synchronizes (matches and untangles by referentially numbering components and systems with 101, 201, etc. to synchronize their order numbers and their reference numbers) all components and systems of each invention (to create systemized, orderedly numbered, categorized, and synchronized components and systems).
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
5) The unique system formulates (standardizes and untangles) the different, complicated, hard-to-understand, unorganized, messy, unordered, unformulated specification of each invention into 20 simplest-descriptive-level formulas (to create simplest, easy-to-understand, organized, systematized, categorized, orderedly numbered, and formulated specifications).
   (Each of the 20 simplest-descriptive-level formulas is for describing only one aspect of each component (at the simplest descriptive level).
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
   (With the current technique, used nationwide and worldwide, by ALL inventors/patent lawyers/engineers/manufacturers/scientists/educators/students/people from all walks of life/etc., millions of patent specifications have been written and formatted in millions of different ways (Each patent specification is written & formatted differently from the rest). To search for, refer to, and understand the materials, shapes, connections, functions, etc. of millions of components of these millions of different, complicated, hard-to-understand, unorganized, messy, unformulated patent specifications are absolutely painful and tedious nightmares.
   They are humongous wastes of time, money, and intellectual resources.
6) The unique system simplifies (to the simplest descriptive level) the different, complicated, hard-to-understand, unorganized, messy, unordered, unformulated specification of each invention into one single system of 20 simplest, easy-to-understand, organized, systematized, categorized, orderedly numbered, untangling, and simplifying formulas.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
7) The unique system uses adverbs ‘each’ and ‘respectively’ with plural-form verb to always describe all multiple identical components and systems of each invention in singular format (at the simplest descriptive level).
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
8) The unique system of 20 simplest-descriptive-level formulas saves humongous amounts of time on patent searches & patent references for USPTO examining lawyers/inventors/patent lawyers/engineers/manufacturers/scientists/educators/students/people from all walks of life/etc.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
9) The unique system of 20 simplest-descriptive-level formulas helps patent searches and patent references be done quickly & easily by USPTO examining lawyers/inventors/patent lawyers/engineers/manufacturers/scientists/educators/students/people from all walks of life/etc.
   (The identical list (used with each of the 20 simplest-descriptive-level formulas) of all systemized, orderedly numbered, categorized, synchronized, and formulated components and systems of each invention allows inventors/engineers/manufacturers/scientists/educators/students/people from all walks of life/etc. to:
      a) Quickly and easily invent all the aspects of all components and systems of each invention,
         (individually and collectively),
      b) Quickly and easily describe all the aspects of all components and systems of each invention,
         (individually and collectively),
      c) Quickly and easily search for all the aspects of all components and systems of each invention,
         (individually and collectively),
      d) Quickly and easily prefer to all the aspects of all components and systems of each invention,
         (individually and collectively),
      e) Quickly and easily understand all the aspects of all components and systems of each invention,
         (individually and collectively),
      f) Quickly and easily learn from all the aspects of all components and systems of each invention,
         (individually and collectively),
      g) Quickly and easily improve all the aspects of all components and systems of each invention,
         (individually and collectively),
      h) Quickly and easily benefit from all the aspects of all components and systems of each invention,
         (individually and collectively),
      i) Quickly and easily make all components and systems of each invention,
      j) Quickly and easily use all components and systems of each invention,
      k) Quickly and easily distribute all components and systems of each invention, and
      l) Quickly and easily sell all components and systems of each invention.
10) The unique system puts its 20 simplest-descriptive-level formulas into the hands of millions of inventors/engineers/manufacturers/scientists/educators/students/people from all walks of life/etc.
   (who do not have money to hire patent law firms to draft and file patent applications for millions of their inventions).
11) The unique system puts the capability of quickly and easily describing each invention
   (by applying its 20 simplest-descriptive-level formulas) into the hands of millions of inventors/engineers/manufacturers/scientists/educators/students/people from all walks of life/etc.
   (who do not have money to hire patent law firms to draft and file patent applications for millions of their inventions).
12) The unique system puts the capability of quickly and easily describing an unlimited numbers of components of each invention
   (by applying its 20 simplest-descriptive-level formulas) into the hands of millions of inventors/engineers/manufacturers/scientists/educators/students/people from all walks of life/etc.
   (who do not have money to hire patent law firms to draft and file patent applications for millions of their inventions).
13) The unique system puts the capability of quickly and easily patent-searching an unlimited numbers of components of each invention
   (by applying its 20 simplest-descriptive-level formulas) into the hands of millions of inventors/engineers/manufacturers/scientists/educators/students/people from all walks of life/etc.
   (who do not have money to hire patent law firms to draft and file patent applications for millions of their inventions).
14) The unique system puts the capability of quickly and easily referencing an unlimited numbers of components of each invention
   (by applying its 20 simplest-descriptive-level formulas) into the hands of millions of inventors/engineers/manufacturers/scientists/educators/students/people from all walks of life/etc.
   (who do not have money to hire patent law firms to draft and file patent applications for millions of their inventions).
15) The unique system provides inventors/engineers/manufacturers/scientists/educators/students/people from all walks of life/etc. with its 20 simplest-descriptive-level formulas to describe and understand each and every component and each and every aspect of each and every component of their invention, at the simplest descriptive level, to understand their inventions the most clearly to create their best inventions.
16) The unique system helps inventors/engineers/manufacturers/scientists/educators/students/people from all walks of life/etc. utilize their best inventive capabilities to create their most valuable inventions.
17) The unique system also color-codes, highlights, boldfaces, underlines, italicizes, uppercases, lowercases, upsizes, downsizes, font-changes the formulated specification of all systemized, orderedly numbered, categorized, synchronized, and formulated components and systems of each invention.
18) The unique system provides 20 simplest, easy-to-understand, organized, systematized, categorized, orderedly numbered, untangling, and simplifying formulas, working together as one single system.
19) The unique system of 20 simplest, easy-to-understand, organized, systematized, categorized, orderedly numbered, untangling, and simplifying formulas open the flood gate for millions of new inventions to be invented.
20) The unique system advances the invention-and-patent world, by providing 20 simplest, easy-to-understand, organized, systematized, categorized, orderedly numbered, untangling, and simplifying formulas, which:
   a) Systematizes (groups together and untangles),
   b) Orderedly numbers (orders and untangles),
   c) Categorizes (sectionizes and untangles),
   d) Synchronizes (matches and untangles),
   e) Formulates (standardizes and untangles), and
   f) Simplifies (to the simplest descriptive level)
   the specifications of all components and all aspects of all components of inventions.
   The 20 simplest-descriptive-level formulas will open the flood gates of millions of new inventions, and will advance the economy.
   The 20 simplest-descriptive-level formulas will also help inventors maximize their inventive capabilities, and protect all their inventions in confidentiality.

### A) Enhancing Inventors' Capability

21) The unique system provides people of almost any age with a substantially effective and efficient method to quickly, easily, and clearly describe, understand, and invent inventions substantially better, by breaking the description of an invention into 20 simple formulas. Each of the simple formulas is for describing only one aspect of the invention (at the simplest descriptive level). This allows people of almost any age to quickly, easily, and clearly understand all the aspects of the invention (individually and collectively).
22) The unique system allows people of almost any age to quickly, easily, and clearly describe, specify, and broaden the scope of their inventions substantially better, by using the 20 simplest-descriptive-level formulas to create 20 simplest-descriptive-level categories. Each of the 20 simplest-descriptive-level categories is for describing only one aspect of each invention (at the simplest descriptive level). The 20 simplest-descriptive-level categories are, as follows: title, figure, component, material, shape, dimension, smell, taste, finish, design, color, sound, property, connection, function, component advantage, invention advantage, operation, variation, and ramification.
23) The unique system allows people of almost any age to enhance their inventive capability substantially, by allowing them to quickly, easily, and clearly describe, understand, and invent all the aspects of all the components of each invention (at the simplest descriptive level).
24) The unique system allows people of almost any age to enhance their inventive capability substantially, by allowing them to be able to compare new unobvious advantages their inventions provide to old obvious disadvantages prior-art inventions provide (at the simplest descriptive level).

### B) Elevating their Inventions' Patentability

25) The unique system allows people of almost any age to elevate the patentability of their inventions, by allowing them to quickly, easily, and clearly understanding how many necessary components an invention needs to comprise to be complete and functional (at the simplest descriptive level).
26) The unique system allows people of almost any age to elevate the patentability of their inventions, by allowing them to quickly, easily, and clearly understanding what material each component of each invention is made of (at the simplest descriptive level).
27) The unique system allows people of almost any age to elevate the patentability of their inventions, by allowing them to quickly, easily, and clearly understanding what shape each component of each invention has (at the simplest descriptive level).
28) The unique system allows people of almost any age to elevate the patentability of their inventions, by allowing them to quickly, easily, and clearly understanding what dimension, smell, taste, and feel each component of each invention has (at the simplest descriptive level).
29) The unique system allows people of almost any age to elevate the patentability of their inventions, by allowing them to quickly, easily, and clearly understanding what sound each component of each invention makes (at the simplest descriptive level).
30) The unique system allows people of almost any age to elevate the patentability of their inventions, by allowing them to quickly, easily, and clearly understanding how each component of each invention is connected to other components (at the simplest descriptive level).
31) The unique system allows people of almost any age to elevate the patentability of their inventions, by allowing them to quickly, easily, and clearly understanding how each component of each invention functions (at the simplest descriptive level).
32) The unique system allows people of almost any age to elevate the patentability of their inventions, by allowing them to quickly, easily, and clearly understanding how each invention operates, what purposes each invention serves, what advantages each invention provides, what variations each invention has, and what ramifications each invention has (at the simplest descriptive level).

### C) Preserving Inventors' Rights, Eliminating Financial Obstacles, and Saving them a Lot of Money

33) The unique system allows people of almost any age to quickly and easily learn the 20 simplest-descriptive-level formulas, to preserve their rights to potential patents with ‘patent pending’ status for their inventions, on their own. Each of the 20 simplest-descriptive-level formulas is for describing only one aspect of the invention (at the simplest descriptive level). For example, an inventor can learn how to use the 20 simplest-descriptive-level formulas, within an hour.
34) The unique system provides people of almost any age with the capability to describe as many inventions as they want and to preserve their rights to potential patents with ‘patent pending’ status for their inventions, on their own. This eliminates the high cost of patent legal services.
35) The unique system eliminates the devastating problem of invention theft, by providing people of almost any age with the capability to describe their inventions and to preserve their rights to potential patents with ‘patent pending’ status, on their own, in total confidentiality. For example, inventors don't have to disclose their valuable inventions to total strangers for help with describing their inventions.
36) The unique system eliminates the financial roadblock created by the high cost of patent legal services, and saves significant amounts of money for people (Inventors don't have to blindly waste money on patent legal services for inventions before they are proven in the marketplace), by providing people of almost any age with the capability to describe as many inventions as they want and to preserve their rights to potential patents with ‘patent pending’ status for their inventions, on their own.
37) The unique system eliminates the financial roadblock created by the high cost of invention-drawing services, and saves significant amounts of money for people (Inventors don't have to blindly waste money on invention-drawing services for inventions before they are proven in the marketplace), by providing people of almost any age with the capability to hand-draw and/or computer-draw as many inventions as they want, on their own.

### D) Maximizing the Inventive Capability of Brilliant Inventors

38) The unique system allows people to utilize their brilliant minds to their maximum capability, by eliminating the financial obstacle of the high cost of patent legal services. For example, because inventors don't need any money to pay for patent legal services, they can freely invent to come up with as many brilliant inventions as possible, and can preserve their rights to potential patents with ‘patent pending’ status, on their own.
39) The unique system allows all brilliant minds to:
   Freely invent as many brilliant inventions as they want, and
   Freely preserve their rights to potential patents with ‘patent pending’ status for as many brilliant inventions as they want.
40) The unique system allows each inventor to present, not one, but multiple ‘patent pending’ inventions, at the same time, to prospective companies. This will increase each inventor's success rate of selling and/or licensing his inventions to the prospective companies;
41) The unique system allows prospective companies to have, not one, but multiple ‘patent pending’ inventions to choose from, at the same time, from each inventor. This will increase the prospective companies' success rate of profiting from each inventor's inventions.

### E) Filtering Out Unwanted Inventions, and Increasing the Number of Wanted Inventions, Substantially

42) The unique system allows prospective companies to:
   Filter out all unwanted inventions presented by inventors because the prospective companies have direct contact with consumers so they know what consumers don't want,
   Sign contracts with inventors to buy the legal rights of only wanted inventions or to be licensed to produce and sell only wanted inventions presented by inventors because the prospective companies have direct contact with consumers so they know what consumers want,
   Save significant amounts of time and money from their own research and development, and
   On behalf of inventors, hire patent law firms to file non-provisional patent applications for only the wanted inventions with the USPTO.
43) The unique system allows inventors to present, not one, but multiple ‘patent pending’ inventions, at the same time, to prospective companies. This allows the inventors to:
   Know which inventions are unwanted to avoid investing their inventive capability in them,
   Know which inventions are wanted to invest their inventive capability in them and, thus, save significant amounts of time and money from their own research and development,
   Focus their inventive capability on inventing only wanted inventions, and thus
   Increase the number of wanted inventions they will come up with, substantially.

### F) Preventing Unwanted Inventions from being Filed with the Patent and Trademark Office (USPTO)

44) The unique system eliminates and prevents all unwanted inventions from being filed with the USPTO because after all the unwanted inventions are filtered out, neither inventors nor prospective companies want to waste money for patent law firms to file non-provisional patent applications for the unwanted inventions with the USPTO. This eliminates all unnecessary workloads on the USPTO, and solves the long-felt problem of the USPTO having been overwhelmed with so many patent applications for unwanted inventions, which have wasted precious intellectual resources from inventors, companies, the USPTO, and, thus, the economy.

### G) Increasing Inventors' Revenues, Substantially, and Increasing Companies' Revenues, Substantially

45) The unique system allows inventors to avoid wasting their intellectual resources and their hard-earned money on unwanted inventions and the high cost of patent legal services.
46) The unique system, substantially, increases the number of brilliant inventions (invented by inventors and sold or licensed to companies to produce and sell to consumers, to advance the economy). Therefore, the unique system increases the number of contracts signed between inventors and companies, and, thus, inventors' and companies' revenues, substantially.
47) The unique system, substantially, increases the number of products (embodying brilliant inventions from inventors, produced by companies, and sold to consumers, to advance the economy).

### H) Increasing Patent Law Firms' Revenues, Substantially

48) The unique system increases patent law firms' revenues, substantially, by increasing the number of non-provisional patent applications (for only wanted inventions) to be filed with the USPTO, substantially, as follows:
   a) Each inventor unguidedly comes up with multiple unwanted inventions:
      Without the unique system, each inventor comes up with multiple inventions, and only has enough financial resource to hire a patent law firm to file a none-provisional patent application for one of his inventions. If this invention he presents to prospective companies is an unwanted invention (most of inventions are unwanted inventions because inventors don't have direct contact with consumers like prospective companies do so they don't know what consumers want), prospective companies will not want to invest in and lose money from it. The inventor doesn't want to waste any more of his hard-earned money and years of his life waiting, and thus, decides not to invent any more. As a result, the patent law firm gets only one order of filing a non-provisional patent application from the inventor.
   b) Each inventor guidedly comes up with multiple wanted inventions:
      With the unique system, each inventor can eliminate the high cost of patent law firm. Therefore, each inventor can freely invent to come up with multiple inventions and file provisional patent applications to get ‘patent pending’ status to preserve his rights to potential patents for all his inventions, on his own. Among each inventor's inventions presented, prospective companies will be able to pick out a wanted invention to invest in and profit from. The prospective companies will want each inventor to keep coming up with wanted inventions so they can save money on their own research and development. Knowing what wanted inventions are, each inventor starts focusing his inventive capability on coming up with only wanted inventions. Therefore, the number of wanted inventions each inventor will come up with will increase substantially, and each inventor will be able to sell and/or license, not one, but multiple wanted inventions to prospective companies. As a result, the patent law firm will keep getting, not one, but multiple substantial orders of filing non-provisional patent applications from each inventor and/or prospective companies.
   Therefore, the unique system increases patent law firms' revenues, substantially.

### I) Learning and Referring to the 20 Simplest-Descriptive-Level Formulas, Quickly and Easily (Via Mobile Devices)

49) The unique system increases the convenience of mobile devices (e.g., smart phone, tablet, etc.) and eliminates the need for expensive cumbersome stationary devices (e.g., desktop computer, etc.) because the 20 simplest-descriptive-level formulas is invented to be large enough to be functionally legible within the dimension of the screen of mobile devices. This eliminates the inconvenient needs for people to enlarge and move the content of a file around, within the screen. Therefore, people of almost any age can learn and refer to the 20 simplest-descriptive-level formulas, quickly and easily, via mobile devices.
50) The unique system increases the practicality of mobile devices (e.g., smart phone, tablet, etc.) and eliminates the need for expensive cumbersome stationary devices (e.g., desktop computer, etc.) because the 20 simplest-descriptive-level formulas is invented to be large enough to be functionally legible within the dimension of the screen of mobile devices. This eliminates the inconvenient needs for people to enlarge and move the content of a file around, within the screen. Therefore, people of almost any age can learn and refer to the 20 simplest-descriptive-level formulas, quickly and easily, via mobile devices.
51) The unique system increases the usability of mobile devices (e.g., smart phone, tablet, etc.) and eliminates the need for expensive cumbersome stationary devices (e.g., desktop computer, etc.) because the 20 simplest-descriptive-level formulas is invented to be large enough to be functionally legible within the dimension of the screen of mobile devices. This eliminates the inconvenient needs for people to enlarge and move the content of a file around, within the screen. Therefore, people of almost any age can learn and refer to the 20 simplest-descriptive-level formulas, quickly and easily, via mobile devices.
52) The unique system increases the value of mobile devices (e.g., smart phone, tablet, etc.) and eliminates the need for expensive cumbersome stationary devices (e.g., desktop computer, etc.) because the 20 simplest-descriptive-level formulas is invented to be large enough to be functionally legible within the dimension of the screen of mobile devices. This eliminates the inconvenient needs for people to enlarge and move the content of a file around, within the screen. Therefore, people of almost any age can learn and refer to the 20 simplest-descriptive-level formulas, quickly and easily, via mobile devices.

### J) Learning and Referring to the 20 Simplest-Descriptive-Level Formulas (Via Mobile Devices, at any Time and Place), and Inventing and Describing Inventions (Via Mobile Devices, at any Time and Place)

53) The unique system allows people to learn and refer to the 20 simplest-descriptive-level formulas quickly and easily at any time and place (e.g., on a walk, in a park, on a beach, at a bus stop, in a meeting, etc.) via mobile devices (e.g., smart phone, tablet, etc.) because the 20 simplest-descriptive-level formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the 20 simplest-descriptive-level formulas, quickly and easily, via mobile devices.
   This eliminates the need for expensive cumbersome stationary devices (e.g., desktop computer, etc.).
54) The unique system allows people to invent and record inventions, conveniently, at any time and place (e.g., on a walk, in a park, on a beach, at a bus stop, in a meeting, etc.) via mobile devices (e.g., smart phone, tablet, etc.) because the 20 simplest-descriptive-level formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the 20 simplest-descriptive-level formulas, quickly and easily, via mobile devices.
   This eliminates the need for expensive cumbersome stationary devices (e.g., desktop computer, etc.).
55) The unique system allows people to describe inventions by using voice-to-text function, at any time and place (e.g., on a walk, in a park, on a beach, at a bus stop, in a meeting, etc.) via mobile devices (e.g., smart phone, tablet, etc.) because the 20 simplest-descriptive-level formulas is invented to be large enough to be functionally legible within the dimension of the screen of mobile devices. This eliminates the inconvenient needs for people to enlarge and move the content of a file around within the screen, constantly. Therefore, people of almost any age can learn and refer to the 20 simplest-descriptive-level formulas, quickly and easily, via mobile devices.
   This eliminates the need for expensive cumbersome stationary devices (e.g., desktop computer, etc.).

### K) Transmitting Inventions Between Mobile Devices, Stationary Devices, and the Internet

56) The unique system increases the convenience, practicality, usability, value of software used on mobile devices (e.g., smart phone, tablet, etc.), with the synergism of the 20 simplest-descriptive-level formulas, software, and mobile devices.
57) The unique system allows people to:
   Learn the 20 simplest-descriptive-level formulas
   (by using converting-voice-to-text function, converting-text-to-voice function, voice command, touch command, signal command, mechanical command, etc.), at any time and place, via software used on mobile devices
      (e.g., smart phone, tablet, etc.);
   Refer to the 20 simplest-descriptive-level formulas
   (by using converting-voice-to-text function, converting-text-to-voice function, voice command, touch command, signal command, mechanical command, etc.), at any time and place, via software used on mobile devices
      (e.g., smart phone, tablet, etc.);
   Invent and record inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Describe inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Draw inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Store inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Transmit inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Share inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Email inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   Fill out patent applications for inventions,
   (by using converting-voice-to-text function, converting-text-to-voice function, voice command, touch command, signal command, mechanical command, etc.), at any time and place, via software used on mobile devices
      (e.g., smart phone, tablet, etc.);
   File patent applications for inventions,
   (by using converting-voice-to-text function, converting-text-to-voice function, voice command, touch command, signal command, mechanical command, etc.), at any time and place, via software used on mobile devices
      (e.g., smart phone, tablet, etc.); and
   Pay filing fees for patent applications,
   (by using converting-voice-to-text function, converting-text-to-voice function, voice command, touch command, signal command, mechanical command, etc.), at any time and place, via software used on mobile devices
      (e.g., smart phone, tablet, etc.).
58) The unique system allows people to use all the possible functions of software used on mobile devices (for example, some functions are: converting voice to text, converting text to voice, activating by voice, activating by touch, wireless or wired uploading, wireless or wired downloading, wireless or wired transmitting, etc.), to eliminate the needs for using cumbersome pen and paper, to:
   Learn the 20 simplest-descriptive-level formulas, at any time and place
      (e.g., on a walk, in a park, on a beach, at a bus stop, in a meeting, etc.);
   Refer to the 20 simplest-descriptive-level formulas, at any time and place
      (e.g., on a walk, in a park, on a beach, at a bus stop, in a meeting, etc.);
   Invent and record inventions, at any time and place
      (e.g., on a walk, in a park, on a beach, at a bus stop, in a meeting, etc.);
   Describe inventions, at any time and place
      (e.g., on a walk, in a park, on a beach, at a bus stop, in a meeting, etc.); and
   Draw inventions, at any time and place
      (e.g., on a walk, in a park, on a beach, at a bus stop, in a meeting, etc.).
   Store inventions, at any time and place
      (e.g., on a walk, in a park, on a beach, at a bus stop, in a meeting, etc.).
   Transmit inventions, at any time and place
      (e.g., on a walk, in a park, on a beach, at a bus stop, in a meeting, etc.).
   Share inventions, at any time and place
      (e.g., on a walk, in a park, on a beach, at a bus stop, in a meeting, etc.).
   Email inventions, at any time and place
      (e.g., on a walk, in a park, on a beach, at a bus stop, in a meeting, etc.).
   Fill out patent applications for inventions, at any time and place
      (e.g., on a walk, in a park, on a beach, at a bus stop, in a meeting, etc.).
   File patent applications for inventions, at any time and place
      (e.g., on a walk, in a park, on a beach, at a bus stop, in a meeting, etc.).
   Pay filing fees for patent applications, at any time and place
      (e.g., on a walk, in a park, on a beach, at a bus stop, in a meeting, etc.).
59) The unique system allows people to conveniently transmit inventions electronically:
   Between mobile devices and mobile devices (e.g., smart phone, tablet, etc.) to share, to store, to file provisional or non-provisional patent applications, etc. (for example, in a meeting, at a conference, etc.), at any time and place;
   Between mobile devices and stationary devices (e.g., desktop computer, etc.) to share, to store, to file provisional or non-provisional patent applications, etc. (for example, on Sugarsync for future use, etc.), at any time and place;
   Between mobile devices and the internet (e.g., the USPTO's website, email acc., etc.) to share, to store, to file provisional or non-provisional patent applications, etc., at any time and place; and
   Between stationary devices and the internet (e.g., the USPTO's website, email acc., etc.) to share, to store, to file provisional or non-provisional patent applications, etc., at any time and place.

### L) Best Maximizing the Capability of Precious Intellectual Resources, Nationally and Globally

60) The unique system allows people and/or prospective companies to:
   Quickly and easily free themselves to invent as many inventions as they want, by eliminate the financial obstacle of the high cost of patent legal services, which has stifled their inventive capability.
   Quickly and easily use 20 simple formulas to group, formulate, categorize, orderedly increasingly number, sectionize, systematize, untangle, and simplify the specification of all components and all components' aspects of all their inventions, to the simplest descriptive level, regardless of the number of components each invention comprises
      (for example, an invention can comprise 10 or 10,000 components).
   Quickly and easily file provisional patent applications to preserve their rights with ‘patent pending’ status for all their inventions, on their own, in total confidentiality,
   Quickly and easily filter out all unwanted inventions,
   Quickly and easily focus on inventing only wanted inventions,
   Quickly and easily save significant amounts of time and money from their own research and development,
   Quickly and easily increase the number of wanted inventions invented, substantially,
   Quickly and easily increase the number of contracts signed between them, substantially,
   Quickly and easily increase the revenues of inventor and prospective companies, substantially,
   Quickly and easily increase the number of orders placed with patent law firms to file non-provisional patent applications for only their wanted inventions.
      This increases the revenues of patent law firms, substantially,
   Quickly and easily learn the 20 simplest-descriptive-level formulas, via mobile devices, at any place and time,
   Quickly and easily refer to the 20 simplest-descriptive-level formulas, via mobile devices, at any place and time,
   Quickly and easily invent and record inventions, via mobile devices, at any place and time,
   Quickly and easily describe inventions, via mobile devices, at any place and time,
   Quickly and easily draw inventions, via mobile devices, at any place and time,
   Quickly and easily store inventions, via mobile devices, at any place and time,
   Quickly and easily transmit inventions, via mobile devices, at any place and time,
   Quickly and easily share inventions, via mobile devices, at any place and time,
   Quickly and easily email inventions, via mobile devices, at any place and time,
   Quickly and easily fill out patent applications for inventions, via mobile devices, at any place and time,
   Quickly and easily file patent applications for inventions, via mobile devices, at any place and time,
   Quickly and easily pay patent-filing fees for patent applications, via mobile devices, at any place and time, and
   Quickly and easily eliminate and prevent all unwanted inventions from being filed with the USPTO.
   This eliminates all unnecessary workloads on the USPTO, and solves the long-felt problems of the USPTO having been overwhelmed with so many patent applications for unwanted inventions, which have wasted precious intellectual resources from inventors, companies, patent law firms, the USPTO, and, thus, the economy.
   (When do patent searches)
   Quickly and easily find out the detailed info of each component in each category of title, figure, component, material, shape, dimension, smell, taste, finish, design, color, sound, property, connection, function, component advantage, invention advantage, operation, variation, and ramification, by quickly and easily be able to refer to the ‘same order number’ of each component in each category of title, figure, component, material, shape, dimension, smell, taste, finish, design, color, sound, property, connection, function, component advantage, invention advantage, operation, variation, and ramification.

Therefore, the unique system best maximizes the capability of precious intellectual resources from inventors, companies, patent law firms, the USPTO, and, thus, the economy.

As the combined results of all the above 60 important advantages, the unique system will advance the economy, significantly.

### BRIEF DESCRIPTION OF THE DRAWINGS

FIG. 1 illustrates the task menu, on a mobile or stationary device (e.g., smart phone, tablet, laptop, desktop computer, etc.).

FIG. 2 illustrates the command menu, on a mobile or stationary device (e.g., smart phone, tablet, laptop, desktop computer, etc.).

FIG. 3 illustrates two of 20 simplest-descriptive-level formulas, on a mobile or stationary device (e.g., smart phone, tablet, laptop, desktop computer, etc.).

FIG. 4 illustrates the component formula and its category, which describes only the components, at the simplest descriptive level, on a mobile or stationary device (e.g., smart phone, tablet, laptop, desktop computer, etc.).

FIG. 5 illustrates a zoomed-in perspective view of the sample invention of footwear, displayed by a mobile application, on a mobile or stationary device (e.g., smart phone, tablet, laptop, desktop computer, etc.).

FIG. 6A illustrates a zoomed-in left view of the footwear, displayed by the mobile application, on a mobile or stationary device (e.g., smart phone, tablet, laptop, desktop computer, etc).

FIG. 6B illustrates a zoomed-in right view of the footwear, displayed by the mobile application, on a mobile or stationary device (e.g., smart phone, tablet, laptop, desktop computer, etc.).

FIGS. 7 (Prior Art) and 8 (Prior Art) each illustrate the disadvantages of the prior-art method, which are impossible (by simply looking at the drawings or texts) to know where each and every data of each and every component of an invention are stored in a computer memory.

### SUMMARY OF THE INVENTION

A unique system comprises twenty simplest-descriptive-level formulas, at least one mobile or stationary device, and at least one operating and/or applicational software downloaded to the at least one mobile or stationary device for operating the at least one mobile or stationary device. The unique system is for helping a user be able to quickly and easily describe, preserve, retrieve, process, and benefit from inventions. Each of the twenty simplest-descriptive-level formulas is for describing only one aspect of each component of an invention, at the simplest descriptive level such that the related components in each component aspect of the invention are systematized (grouped into systems), and such that the alphanumeric prefix and the alphanumeric suffix of each component in each component aspect match each other and increase sequentially. The twenty simplest-descriptive-level formulas systematize, orderedly number, categorize, synchronize, standardize, and simplify each component description in each component aspect of an invention to the simplest descriptive level.

### DETAILED DESCRIPTION OF THE INVENTION

### Structure

A unique system comprises:
a) 20 simplest-descriptive-level formulas (for example, component formula, connection formula, function formula, etc.) for describing inventions;
b) At least one software (for example, operating software, applicational software, etc.) for performing all possible software functions; and
c) At least one device (for example, mobile device or stationary device, such as smart phone, tablet, laptop, desktop or stationary computer, etc., which can perform a variety of functions such as, storing, displaying, describing, drawing, sharing, emailing, transmitting, filling out, filing, paying fee for, etc. . . . the 20 simple formulas, inventions, patent-application form, patent application, etc., wirelessly or wiredly).

The at least one device comprises:
a monitor,
a memory for storing the 20 formulas and the at least one software, and
a processor coupled to the memory
   for executing the at least one software,
   for processing input from a user, and
   for displaying inventions and the 20 formulas on the monitor.

Each of the 20 simplest-descriptive-level formulas is for describing only one aspect of each component of an invention (at the simplest descriptive level). The 20 simplest-descriptive-level formulas are for describing the following twenty aspects of an invention, respectively:

1) Title, 2) Figure, 3) Component, 4) Material, 5) Shape, 6) Dimension, 7) Smell, 8) Taste, 9) Finish, 10) Design, 11) Color, 12) Sound, 13) Property, 14) Connection, 15) Function, 16) Component Advantage, 17) Invention Advantage, 18) Operation, 19) Variation, 20) Ramification.

### An Invention can Comprise at Least One System

### Each of the at Least One System can Comprise at Least One Component

In each of 20 simplest-descriptive-level formulas below:
a) Each verb is conjugated, and
b) Adverb ‘each’ or ‘respectively’ can be added when a verb is in plural form, to eliminate the needs for repeating an identical description multiple times
   (to simplify the description to the simplest descriptive level).

In each of 20 simplest-descriptive-level formulas below:
a) Abbreviation ‘Ord.’ stands for ‘Order’,
b) Abbreviation ‘No.’ stands for ‘Number’,
c) Abbreviation ‘Sys.’ stands for ‘System’, and
d) Abbreviation ‘Comp.’ stands for ‘Component’.

### The 20 Simplest-Descriptive-Level Formulas Comprise

1) Title Formula for describing only what title an invention has:

| | | |
|---|---|---|
| The invention | for | what purpose(s) |

2) Figure Formula for briefly describing only what figure(s) an invention has:

| | | |
|---|---|---|
| Figure no.(s) | illustrate(s) | what view(s) of what |

3) Component Formula for describing only what system(s) of systemized, sectionized, orderedly numbered, and synchronized component(s) an invention comprises.

An invention can comprise at least one system.

Each of the at least one system can comprise at least one component:

| | | |
|---|---|---|
| Invention | comprises: | at least one of ord. no. system(s), (each) |
| | | comprising: |
| | | at least one of ord. no. component(s). |

The following is an equivalent Component Formula equivalent to the Component Formula above:

| | | |
|---|---|---|
| Invention | comprises: | at least one of ord. no. system(s), (each of) |
| | | which comprises: |
| | | at least one of ord. no. component(s). |

4) Material Formula for describing only what material(s) each component is made of:

| | | | |
|---|---|---|---|
| Ord. no. | sys.(s) or comp.(s) | (each) be made of | what material(s) |

5) Shape Formula for describing only what shape(s) each component has:

| | | | |
|---|---|---|---|
| Ord. no. | sys.(s) or comp.(s) | (each) have | what shape(s) |

6) Dimension Formula for describing only what dimension(s) each component has:

| | | | |
|---|---|---|---|
| Ord. no. | sys.(s) or comp.(s) | (each) have | what dimension(s) |

7) Smell Formula for describing only what smell(s) each component has:

| | | | |
|---|---|---|---|
| Ord. no. | sys.(s) or comp.(s) | (each) have | what smell(s) |

8) Taste Formula for describing only what taste(s) each component has:

| | | | |
|---|---|---|---|
| Ord. no. | sys.(s) or comp.(s) | (each) have | what taste(s) |

9) Finish Formula for describing only what surface finish(s) each component has:

| | | | |
|---|---|---|---|
| Ord. no. | sys.(s) or comp.(s) | (each) have | what finish(s) |

10) Design Formula for describing only what surface design(s) each component has:

| | | | |
|---|---|---|---|
| Ord. no. | sys.(s) or comp.(s) | (each) have | what design(s) |

11) Color Formula for describing only what color(s) each component has:

| | | | |
|---|---|---|---|
| Ord. no. | sys.(s) or comp.(s) | (each) have | what color(s) |

12) Sound Formula for describing only what sound(s) each component makes:

| | | | |
|---|---|---|---|
| Ord. no. | sys.(s) or comp.(s) | (each) make | what sound(s) |

13) Property Formula for describing only what property(s) each component has:

| | | | |
|---|---|---|---|
| Ord. no. | sys.(s) or comp.(s) | (each) have | what property(s) |

14) Connection Formula for describing only how each component is connected to other(s):

| | | | | |
|---|---|---|---|---|
| How | ord. no. | sys.(s) or comp.(s) | (respectively) | what other(s) |
| | | | be connected to | |

15) Function Formula for describing only what function(s) each component is for:

| | | | |
|---|---|---|---|
| Ord. no. | sys.(s) or comp.(s) | (respectively) be for | what function(s) |

16) Comp. Advantage Formula for describing only what advantage(s) each component is for:

| | | | |
|---|---|---|---|
| Ord. no. | sys.(s) or comp.(s) | (respectively) be for | what advantage(s) |

17) Invention Advantage Formula for describing only what advantage(s) an invention is for:

| | | |
|---|---|---|
| Invention | (respectively) be for | what advantage(s) |

18) Operation Formula for describing only what step(s) the operation comprises:

| | | |
|---|---|---|
| Operation | comprises: | what step(s) |

19) Variation Formula for describing only what variation(s) each component has:

| | | | |
|---|---|---|---|
| Ord. no. | sys.(s) or comp.(s) | can comprise, be, | what variation(s) |
| | | have, or make | |

20) Ramification Formula for describing only what ramification(s) each component has:

| | | | |
|---|---|---|---|
| Ord. no. | sys.(s) or comp.(s) | can comprise, be, | what ramification(s) |
| | | have, or make | |

### Invention Drawing

Invention-Drawing Method for drawing an invention:

Following the guide line on the website of the USPTO (www.USPTO.gov), computer-draw an invention. Or hand-draw an invention (e.g., using a dark pencil, ball-point pen, gel pen, felt-tip pen, the like, an equivalent, etc.), and then photocopy the figures; and

### Application Filing

Application-Filing Method for filing a provisional patent application:

Following the guide line on the website of the patent office, for example, the USPTO (the United States patent and trademark office) (www.USPTO.gov), file a provisional patent application online on the website, using a required form and paying a required fee (for example, Form SB/16-EFS-Web. Fee $130 US).

Or: 1) Fill out the required form online (for example, Form SB16). Print it out and sign it,
2) Print out the description and drawings of an invention,
3) Buy a money order of the USPS (U.S. postal services) for the filing fee.
4) Mail all items above by using the service of EXPRESS MAIL TO ADDRESSEE, to the USPTO, for example, at: Mail stop: Provisional Patent Application, Commissioner for Patents P.O Box 1450, Alexandria, Va. 22313-1450

### Operation

To describe an invention, at least one of the 20 simplest-descriptive-level formulas of the unique system can be used.

Each of the 20 simplest-descriptive-level formulas is used for describing only one aspect of the invention, at the simplest descriptive level.

### First Example

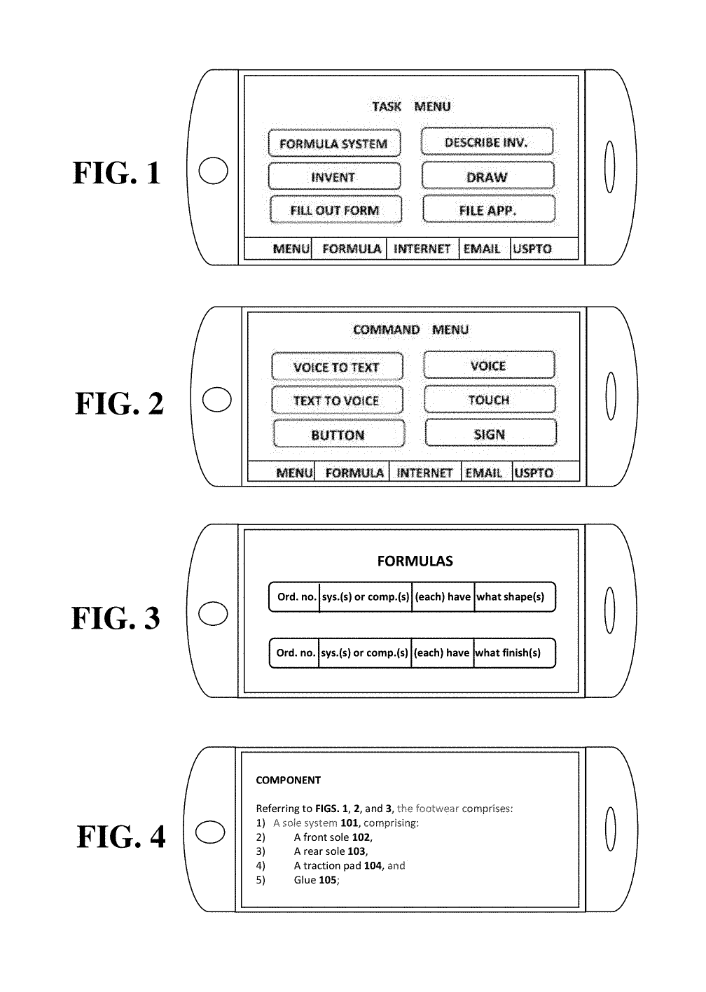

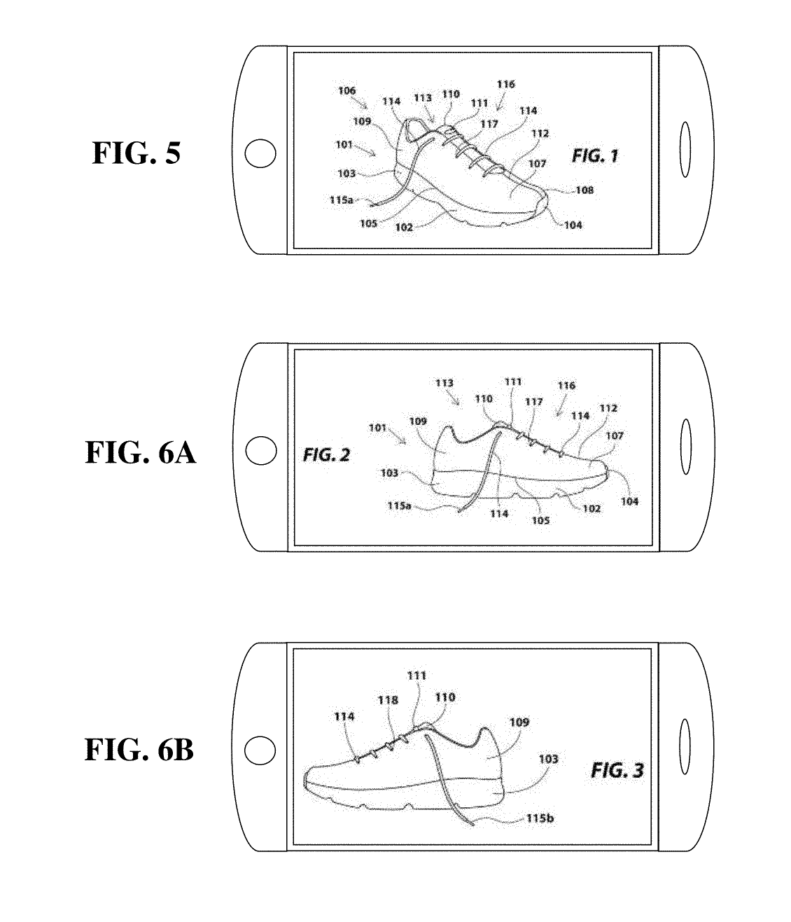

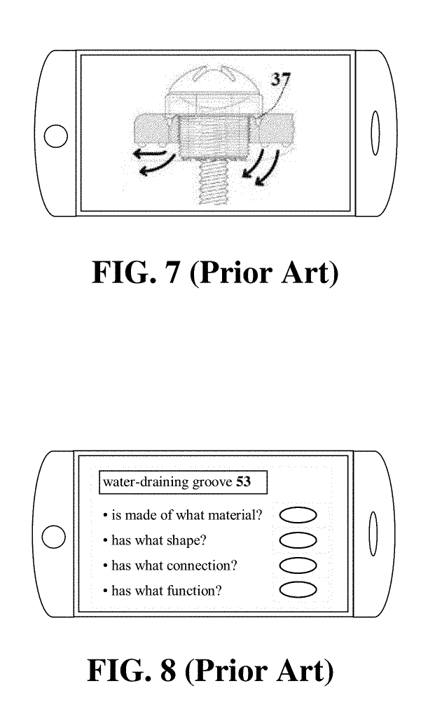

Referring to FIGS. 1, 2, 3, 4, 5, 6A, and 6B, the 20 simplest-descriptive-level formulas can be created as a mobile application and/or can be displayed on or via a mobile device. The 20-simplest-descriptive-level-formula mobile application can be one of the following:
1) Video-and-audio or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.);
2) Video-only or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.);
3) Audio-only or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.);
4) Audio-and-text or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.);
5) Audio-only or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.); and
6) Text-only or e-book application, having all possible software functions. For example, some of the functions an application can have are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.).

### Second Example

Referring to FIGS. 1, 2, 3, 4, 5, 6A, and 6B, the 20 simplest-descriptive-level formulas can be created as a mobile application and/or can be displayed on or via a mobile device. At any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.), an inventor can perform at least one of the following tasks:
1) Learn the 20 simplest-descriptive-level formulas, on or via a mobile device;
2) Refer to the 20 formulas, on or via a mobile device;
3) Invent and record an invention, on or via a mobile device;
4) Describe an invention, on or via a mobile device;
5) Draw an invention, on or via a mobile device;
6) Store an invention, on or via a mobile device;
7) Transmit an invention, on or via a mobile device;
8) Share an invention, on or via a mobile device;
9) Email an invention, on or via a mobile device;
10) Fill out a patent form, on the website of the USPTO, on or via a mobile device;
11) File a patent application, on the website of the USPTO, on or via a mobile device; and
12) Pay a filling fee, on the website of the USPTO, on or via a mobile device.

### Third Example

The unique system of 20 simplest-descriptive-level formulas systematizes (groups together and untangles) all components and all their aspects of inventions. For example:
A sole system 101, comprising:
   A front sole 102,
   A rear sole 103,
   A traction pad 104, and
   Glue 105;

The unique system of 20 simplest-descriptive-level formulas orderedly numbers (orders and untangles) all components and all their aspects of inventions. For example:
1) A sole system 101, comprising:
2) A front sole 102,
3) A rear sole 103,
4) A traction pad 104, and
5) Glue 105;

The unique system of 20 simplest-descriptive-level formulas categorizes (sectionizes and untangles) all components and all their aspects of inventions. For example:

Component

Referring to FIGS. 1, 2, and 3, the footwear comprises:
1) A sole system 101, comprising:
2) A front sole 102,
3) A rear sole 103,
4) A traction pad 104, and
5) Glue 105;

The unique system of 20 simplest-descriptive-level formulas synchronizes (matches and untangles) all components and all their aspects of inventions. For example:

As illustrated in the example below:

Component

Referring to FIGS. 1, 2, and 3, the footwear comprises:
1) A sole system 101, comprising:
2) A front sole 102,
3) A rear sole 103,
4) A traction pad 104, and
5) Glue 105;

As illustrated in the COMPONENT example above:
Order number 1 is synchronized with reference number 1 in reference number 101,
Order number 2 is synchronized with reference number 2 in reference number 102,
Order number 3 is synchronized with reference number 3 in reference number 103,
Order number 4 is synchronized with reference number 4 in reference number 104.

This means that:
Order number “1” (which is the First number, which is sequential Prefix “1”) is matched with number “1” in reference number “101” (which is the Last number, which is “sequential Suffix “1”),
Order number “2” (which is the First number, which is sequential Prefix “2”) is matched with number “2” in reference number “102” (which is the Last number, which is “sequential Suffix “2”),
Order number “3” (which is the First number, which is sequential Prefix “3”) is matched with number “3” in reference number “103” (which is the Last number, which is “sequential Suffix “3”),
Order number “4” (which is the First number, which is sequential Prefix “4”) is matched with number “4” in reference number “104” (which is the Last number, which is “sequential Suffix “4”),
Order number “5” (which is the First number, which is sequential Prefix “5”) is matched with number “5” in reference number “105” (which is the Last number, which is “sequential Suffix “5”).

The unique system of 20 simplest-descriptive-level formulas formulates (standardizes and untangles), and simplifies (to the simplest descriptive level) the specifications of all components and all their aspects of inventions. For example:

Material

Referring to FIGS. 1, 2, 3, 4, 5, 6A, and 6B:
1) Sole system 101 is made of the combined materials of its components.
2) Front sole 102 is made of rubber.
3) Rear sole 103 is made of rubber.
4) Traction pad 104 is made of rubber.
5) Glue 105 is made of glue paste.

### Fourth Example

Referring to FIGS. 1, 2, 3, 4, 5, 6A, and 6B, the 20 simplest-descriptive-level formulas can be created as any mobile application in the first example above (e.g., a video-and-audio mobile application) and/or can be displayed on or via a mobile device (e.g., smart phone, tablet, etc.). At any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.), an inventor can benefit from the unique system, by performing at least one of the tasks in the second example above.

The mobile application of the 20 formulas of the unique system describes a sample invention of footwear. Each of the 20 formulas is used for describing only one aspect of the footwear, at the simplest descriptive level, as follows:

(The indentation below is for ease of reading the example)
1) Title Formula describes only the title (at the simplest descriptive level):

Footwear for Walking and Running
2) Figure Formula describes only the figures (at the simplest descriptive level):

Figure

Referring to FIGS. 1, 2, and 3:
FIG. 1 illustrates a perspective view of a footwear.
FIG. 2 illustrates a left-side view of the footwear.
FIG. 3 illustrates a right-side view of the footwear.
3) Component Formula describes only the components (at the simplest descriptive level):

Component

Referring to FIGS. 1, 2, and 3, the footwear comprises:
1) A sole system 101, comprising:
2) A front sole 102,
3) A rear sole 103,
4) A traction pad 104, and
5) Glue 105;
6) A protecting system 106, comprising:
7) A left wall 107,
8) A right wall 108,
9) A rear wall 109,
10) A tongue 110,
11) A logo pad 111, and
12) Thread 112;
13) A lace system 113, comprising:
14) A lace body 114, and
15) Two lace ends 115a and 115b; and
16) Multiple eyelet systems 116, each comprising:
17) A left eyelet 117, and
18) A right eyelet 118.

As illustrated in the COMPONENT example above, this means that the components of the invention are grouped into SYSTEMS, as follows:
A sole system 101,
A protecting system 106,
A lace system 113, and
Multiple eyelet systems 116).

As illustrated in the COMPONENT example above, this also means that:
Order number “1” (which is the First number, which is sequential Prefix “1”) is matched with number “1” in reference number “101” (which is the Last number, which is “sequential Suffix “1”),
Order number “2” (which is the First number, which is sequential Prefix “2”) is matched with number “2” in reference number “102” (which is the Last number, which is “sequential Suffix “2”),
Order number “3” (which is the First number, which is sequential Prefix “3”) is matched with number “3” in reference number “103” (which is the Last number, which is “sequential Suffix “3”),
Order number “4” (which is the First number, which is sequential Prefix “4”) is matched with number “4” in reference number “104” (which is the Last number, which is “sequential Suffix “4”),
Order number “5” (which is the First number, which is sequential Prefix “5”) is matched with number “5” in reference number “105” (which is the Last number, which is “sequential Suffix “5”),
and so on . . .
4) Material Formula describes only the materials (at the simplest descriptive level):

Material

Referring to FIGS. 1, 2, and 3:
1) Sole system 101 is made of the combined materials of its components.
2) Front sole 102 is made of rubber.
3) Rear sole 103 is made of rubber.
4) Traction pad 104 is made of rubber.
5) Glue 105 is made of glue paste.
6) Protecting system 106 is made of the combined materials of its components.
7) Left wall 107 is made of leather.
8) Right wall 108 is made of leather.
9) Rear wall 109 is made of leather.
10) Tongue 110 is made of leather.
11) Logo pad 111 is made of vinyl.
12) Thread 112 is made of nylon.
13) Lace system 113 is made of the combined materials of its components.
14) Lace body 114 is made of cotton.
15) Lace ends 115a and 115b each are made of plastic.
16) Eyelet systems 116, each are made of the combined materials of its components.
17) Left eyelet 117 are made of aluminum.
18) Right eyelet 118 are made of aluminum.
5) Shape Formula describes only the shapes (at the simplest descriptive level):

Shape

Referring to FIGS. 1, 2, and 3:
1) Sole system 101 has the combined shapes of its components.
2) Front sole 102 has an arrow-head shape.
3) Rear sole 103 has a half-moon shape.
4) Traction pad 104 has a trapezoidal shape.
5) Glue 105 has a glue shape.
6) Protecting system 106 has the combined shapes of its components.
7) Left wall 107 has a curved-triangle shape.
8) Right wall 108 has a curved-triangle shape.
9) Rear wall 109 has a curved-arrow-head shape.
10) Tongue 110 has a shoehorn shape.
11) Logo pad 111 has an oval shape.
12) Thread 112 has a thread shape.
13) Lace system 113 has the combined shapes of its components.
14) Lace body 114 has a lace shape.
15) Lace ends 115a and 115b each have a cylindrical shape.
16) Eyelet systems 116, each have the combined shapes of its components.
17) Left eyelet 117 has a ring shape.
18) Right eyelet 118 has a ring shape.
6) Connection Formula describes only the connections (at the simplest descriptive level):

Connection

Referring to FIGS. 1, 2, and 3:
1) Sole system 101 has the combined connections of its components.
2) Front sole 102 is glued to left wall 107 and right wall 108, at their edges.
3) Rear sole 103 is glued to left wall 107 and right wall 108, at their edges.
4) Traction pad 104 is glued to left wall 107 and right wall 108, at their tips.
5) Glue 105 is glued to front sole 102, rear sole 103, traction pad 104, left wall 107, right wall 108, and rear wall 109.
6) Protecting system 106 has the combined connections of its components.
7) Left wall 107 is sewn to right wall 108.
8) Right wall 108 is sewn to left wall 107.
9) Rear wall 109 is attached to left wall 107 and right wall 108.
10) Tongue 110 is sewn to left wall 107 and right wall 108, at its tip.
11) Logo pad 111 is attached to tongue 110.
12) Thread 112 is sewn on left wall 107, right wall 108, and tongue 110.
13) Lace system 113 has the combined connections of its components.
14) Lace body 114 is attached to lace ends 115a and 115b.
15) Lace ends 115a and 115b respectively are laced through left eyelet 117 and right eyelet 118.
16) Eyelet systems 116 respectively have the combined connections of its components.
17) Left eyelet 117 is riveted to left wall 107, along its upper edge.
18) Right eyelet 118 is riveted to right wall 108, along its upper edge.
7) Function Formula describes only the functions (at the simplest descriptive level):

Function

Referring to FIGS. 1, 2, and 3:
1) Sole system 101 is for performing the combined functions of its components.
2) Front sole 102 is for cushioning a foot.
3) Rear sole 103 is for cushioning a foot.
4) Traction pad 104 is for generating traction on a surface.
5) Glue 105 is for attaching front sole 102, rear sole 103, and traction pad 104 to left wall 107, right wall 108, and rear wall 109.
6) Protecting system 106 is for performing the combined functions of its components.
7) Left wall 107 is for protecting a foot.
8) Right wall 108 is for protecting a foot.
9) Rear wall 109 is for protecting a foot.
10) Tongue 110 is for cushioning and protecting a foot.
11) Logo pad 111 is for advertising a logo.
12) Thread 112 is for sewing left wall 107, right wall 108, and tongue 110 together.
13) Lace system 113 is for performing the combined functions of its components.
14) Lace body 114 is for fastening the footwear on a foot.
15) Lace ends 115a and 115b respectively are for tying to each other.
16) Eyelet systems 116 respectively are for performing the combined functions of its components.
17) Left eyelet 117 is for one of lace ends 115a and 115b to thread therethrough.
18) Right eyelet 118 is for one of lace ends 115a and 115b to thread therethrough.
9) Invention Advantage Formula describes only the invention advantages (at the simplest descriptive level):

Advantage

Referring to FIGS. 1, 2, and 3:
1) The footwear is for providing a walking and running device.
2) The footwear is for providing protection to the foot.
3) The footwear is for providing safety to the foot.
4) The footwear is for providing cushion to the foot.
5) The footwear is for providing comfort to the foot.
6) The footwear is for providing tolerance to the foot.
9) Operation Formula describes only the operation (at the simplest descriptive level):

Operation

Referring to FIGS. 1, 2, and 3, the operation of the footwear comprises the steps of:
1) Sliding the footwear on a foot;
2) Pulling lace system 113 to a desired tension;
3) Tying lace ends 115a and 115b, together; and
4) Wearing the footwear for walking and running.
10) Variation Formula describes only the variations (at the simplest descriptive level):

Variation

Referring to FIGS. 1, 2, and 3:
1) Sole system 101 can have a flat-bottle shape.
2) Front sole 102 can have a non-slip surface.
3) Rear sole 103 can have a non-slip surface.
4) Traction pad 104 can have a non-slip surface.
5) Glue 105 can be highly flexible.
6) Protecting system 106 can be made collapsible or foldable.
7) Left wall 107 can be collapsible.
8) Right wall 108 can be collapsible.
9) Rear wall 109 can be collapsible.
10) Tongue 110 can be foldable.
11) Logo pad 111 can have a triangular shape.
12) Thread 112 can be made of cotton.
13) Lace system 113 can be made of fluorescent, glow-in-the-dark material.
14) Lace body 114 can be made of nylon.
15) Lace ends 115a can have a tubular shape.
16) Eyelet systems 116 can be fixed or rotatable.
17) Left eyelet 117 can comprise a steel ring.
18) Right eyelet 118 can comprise a steel ring.

### Fifth Example

The fifth example is identical to the fourth example, except using the equivalent Component Formula, as follows:
. . .
16) Multiple eyelet systems 116, each of which comprises:
. . .

### Sixth Example

An invention specification can comprise:
a) Only Component Formula, or
b) Component Formula and at least one of the 20 simplest-descriptive-level formulas of the unique system.

For example:

Component

Referring to FIGS. 1, 2, and 3, a footwear comprises:
1) A sole system 101, comprising:
2) A front sole 102,
3) A rear sole 103,
4) A traction pad 104, and
5) Glue 105;
6) A protecting system 106, comprising:
7) A left wall 107,
8) A right wall 108,
9) A rear wall 109,
10) A tongue 110,
11) A logo pad 111, and
12) Thread 112;
13) A lace system 113, comprising:
14) A lace body 114, and
15) Two lace ends 115a and 115b; and
16) Multiple eyelet systems 116, each comprising:
17) A left eyelet 117, and
18) A right eyelet 118.

### Seventh Example

The unique system also color-codes, highlights, boldfaces, underlines, italicizes, uppercases, lowercases, upsizes, downsizes, font-changes the formulated specification of all systemized, orderedly numbered, categorized, synchronized, and formulated components and systems of each invention. For example:

Component

Referring to FIGS. 1, 2, and 3, a footwear comprises:
1) A sole system 101, comprising:
2) A front sole 102,
3) A rear sole 103,
4) A traction pad 104, and
5) Glue 105;

### Eighth Example

16) Multiple eyelet systems 116, each comprising:
17) A left eyelet 117, and
18) A right eyelet 118.

Referring to FIGS. 1, 2, 3, 4, 5, 6A, and 6B, at any time and place (e.g., on a walk, in a park, on a beach, at a bus stop, in a meeting, etc.), with all the possible functions of software used on the mobile device (for example, some functions are: sounding, zooming, panning, captioning, fading, sliding, rotating, scrolling, converting voice to text, converting text to voice, activating by voice, activating by touch, activating by signaling, mechanical movement, wireless or wired uploading, wireless or wired downloading, wireless or wired transmitting, wireless or wired signaling, etc.), the inventor can benefit from the unique system, by performing at least one of the following tasks:
1) Learn the 20 simplest-descriptive-level formulas, on or via a mobile or stationary device;
2) Refer to the 20 simplest-descriptive-level formulas, on or via a mobile or stationary device;
3) Invent and record inventions, on or via a mobile or stationary device;
4) Describe inventions, on or via a mobile or stationary device;
5) Draw inventions, on or via a mobile or stationary device;
6) Store inventions, on or via a mobile or stationary device;
7) Transmit inventions, on or via a mobile or stationary device;
8) Share inventions, on or via a mobile or stationary device;
9) Email inventions, on or via a mobile or stationary device;
10) Fill out patent forms for inventions, on or via a mobile or stationary device, or on the website of the USPTO;
11) File patent applications for inventions, on or via a mobile or stationary device, or on the website of the USPTO; and
12) Pay patent-filling fees for patent applications, on or via a mobile or stationary device, or on the website of the USPTO.

As stated in the first, second, and third examples above, the 20 simplest-descriptive-level formulas of the unique system can be created as a mobile or stationary application and/or can be displayed on or via a mobile or stationary device. A mobile device can be a mobile phone, a cellular phone, a handheld computer, a handheld electronic device, a portable media player, a wireless device, a wired device, a tablet computer, a laptop computer, or an equivalent. A stationary device can be a desktop computer, stationary computer, or an equivalent. Each of the 20 simplest-descriptive-level formulas can be used for describing only one aspect of each component of an invention, at the simplest descriptive level.

### Conclusion

### The Present Invention can Efficiently Perform 28 Highly Beneficial Functions (which is Impossible for the Prior Art to do)

The present invention helps computers and people quickly and easily find, go straight to, retrieve, transmit, share, store, process, file, etc. each and every data of each and every component in each and every component aspect (for example, material aspect, shape aspect, connection aspect, function aspect, etc.) displayed on a computer monitor or stored in a computer memory (which is impossible for the prior art to do).

The present invention helps computers and people SYSTEMATIZE related components in each component aspect, and quickly and easily MATCH the sequential PREFIX and the sequential SUFFIX of each and every component name with each other in each and every component aspect (for example, material aspect, shape aspect, connection aspect, function aspect, etc.) to KNOW EXACTLY WHERE each and every data of each and every component in each and every component aspect are displayed on a computer monitor, is described in a specification, or are stored in a computer memory to help computers and people quickly and easily find, go straight to, retrieve, transmit, share, store, process, file, etc. each and every data of each and every component in each and every component aspect displayed on a computer monitor, described in a specification, or stored in a computer memory (which is impossible for the prior art to do).

What is claimed is:

1. A system for describing an invention comprising:
at least one device, said at least one device comprising a monitor, a processor, and a memory;
at least one invention-describing formula,
said at least one invention-describing formula stored in said memory,
said at least one invention-describing formula for describing said invention; and
at least one software,
said at least one software stored in said memory,
said processor coupled to said memory for executing said at least one software,
said processor for processing input from a user,
said processor for displaying said invention and said at least one invention-describing formula on said monitor,
wherein said invention comprises at least one component,
said at least one component is systematized into at least one component system,
each of said at least one component and said at least one component system has a name,
said name comprises a sequential prefix,
a name description,
a reference number, and
a sequential suffix
such that
said sequential prefix and said sequential suffix
match each other and increase sequentially.

2. The system of claim 1, wherein each of said at least one invention-describing formula is selected from the group consisting of:
describing said sequential prefix,
describing said name description,
describing said reference number,
describing said sequential suffix,
describing what each of said at least one component is,
describing the material of each of said at least one component,
describing the shape of each of said at least one component,
describing the dimension of each of said at least one component,
describing the smell of each of said at least one component,
describing the taste of each of said at least one component,
describing the finish of each of said at least one component,
describing the design of each of said at least one component,
describing the color of each of said at least one component,
describing the sound of each of said at least one component,
describing the property of each of said at least one component,
describing the connection of each of said at least one component,
describing the function of each of said at least one component,
describing the advantage of each of said at least one component,
describing the advantage of said invention,
describing the operation of said invention,
describing the variation of said invention,
describing the ramification of said invention,
describing the variation of each of said at least one component, and
describing the ramification of each of said at least one component.

3. The system of claim 1, wherein said reference number of said name is selected from the group consisting of:
100, 1000, 10000, 100000, 1000000,
200, 2000, 20000, 200000, 2000000,
300, 3000, 30000, 300000, 3000000,
400, 4000, 40000, 400000, and 4000000.

4. The system of claim 1, wherein each of said sequential prefix and said sequential suffix is selected from the group consisting of:
at least one alphanumeric character,
at least one numeric character, and
at least one alphabetic character.

5. The system of claim 1, wherein each of said at least one invention-describing formula comprises an answer to a question selected from the group consisting of:
said invention is for what purpose(s)?,
each figure illustrates what view(s)?,
each of said names has what sequential prefix?,
each of said names has what name description?,
each of said names has what reference number?,
each of said names has what sequential suffix?,
said invention comprises what component(s)?,
each of said at least one component is made of what material(s)?,
each of said at least one component has what shape(s)?,
each of said at least one component has what dimension(s)?,
each of said at least one component has what smell(s)?,
each of said at least one component has what taste(s)?,
each of said at least one component has what finish(s)?,
each of said at least one component has what design(s)?,
each of said at least one component has what color(s)?,
each of said at least one component makes what sound(s)?,
each of said at least one component has what property(s)?,
how each of said at least one component is connected to other(s)?,
each of said at least one component is for what function(s)?,
each of said at least one component provides what advantage(s)?,
said invention provides what advantage(s)?,
the operation of said invention comprises what step(s)?,
said invention has what variation(s)?,
said invention has what ramification(s)?,
each of said at least one component has what variation(s)?, and
each of said at least one component has what ramification(s)?.

6. The system of claim 1, further comprising at least one formula selected from the group consisting of:
recording said invention,
describing said invention,
drawing said invention,
displaying said invention,
storing said invention,
transmitting said invention,
sharing said invention,
emailing said invention,
filling out at least one application form for said invention,
filing at least one application form for said invention,
paying at least one application fee for said invention, and
a combination of at least two of the above.

7. The system of claim 1, further comprising at least one formula selected from the group consisting of:
drawing at least one figure of said invention, and
describing said at least one figure of said invention.

8. The system of claim 1, wherein each of said at least one device is selected from the group consisting of:
a mobile phone, a cellular phone, a handheld computer, a handheld electronic device, a portable media player, a wireless device, a tablet computer, a laptop computer, a mobile device, a mobile computer, a desktop or stationary device, a desktop or stationary computer, and a combination of at least two of the above.

9. The system of claim 1, wherein each of said at least one invention-describing formula describes said invention by using a format selected from the group consisting of:
partially or entirely color-coding the description of said invention,
partially or entirely highlighting the description of said invention,
partially or entirely boldfacing the description of said invention,
partially or entirely underlining the description of said invention,
partially or entirely italicizing the description of said invention,
partially or entirely uppercasing the description of said invention,
partially or entirely lowercasing the description of said invention,
partially or entirely upsizing the description of said invention,
partially or entirely downsizing the description of said invention,
partially or entirely font-changing the description of said invention, and
a combination of at least two of the above.

10. The system of claim 1, wherein each of said at least one invention-describing formula partially describes said invention by using a description selected from the group consisting of:
comprises,
each comprise,
respectively comprise,
comprising,
each comprising,
respectively comprising,
is made of the combined materials of its components,
each are made of the combined materials of its components,
has the combined shapes of its components,
each have the combined shapes of its components,
has the combined dimensions of its components,
each have the combined dimensions of its components,
has the combined smells of its components,
each have the combined smells of its components,
has the combined tastes of its components,
each have the combined tastes of its components,
has the combined finishes of its components,
each have the combined finishes of its components,
has the combined designs of its components,
each have the combined designs of its components,
has the combined colors of its components,
each have the combined colors of its components,
has the combined sounds of its components,
each have the combined sounds of its components,
has the combined properties of its components,
each have the combined properties of its components,
has the combined connections of its components,
respectively have the combined connections of its components,
is for performing the combined functions of its components,
respectively are for performing the combined functions of its components, and
a combination of at least two of the above.

11. The system of claim 1, wherein said at least one component is systematized into said at least one component system by using a description selected from the group consisting of:
comprises,
each comprise,
respectively comprise,
comprising,
each comprising, and
respectively comprising.

12. The system of claim 1, wherein each of said at least one component system comprises at least one of said at least on component.

13. The system of claim 1, wherein said at least one component and said at least one component system are described in at least one aspect selected from the group consisting of:
component aspect,
material aspect,
shape aspect,
dimension aspect,
smell aspect,
taste aspect,
finish aspect,
design aspect,
color aspect,
sound aspect,
property aspect,
connection aspect,
function aspect,
advantage aspect,
variation aspect, and
ramification aspect.

14. A method for describing an invention, provided said invention,
said invention comprising at least one component,
said at least one component is systematized into at least one component system,
each of said at least one component and said at least one component system has a name,
said name comprises a sequential prefix,
a name description,
a reference number, and
a sequential suffix
such that
said sequential prefix and said sequential suffix
match each other and increase sequentially,
the method comprising at least one step selected from the group consisting of:
describing the title of said invention,
describing said sequential prefix,
describing said name description,
describing said reference number,
describing said sequential suffix,
describing what each of said at least one component is,
describing the material of each of said at least one component,
describing the shape of each of said at least one component,
describing the dimension of each of said at least one component,
describing the smell of each of said at least one component,
describing the taste of each of said at least one component,
describing the finish of each of said at least one component,
describing the design of each of said at least one component,
describing the color of each of said at least one component,
describing the sound of each of said at least one component,
describing the property of each of said at least one component,
describing the connection of each of said at least one component,
describing the function of each of said at least one component,
describing the advantage of each of said at least one component,
describing the advantage of said invention,
describing the operation of said invention,
describing the variation of said invention,
describing the ramification of said invention,
describing the variation of each of said at least one component, and
describing the ramification of each of said at least one component.

15. The method of claim 14, further comprising at least one step selected from the group consisting of:
drawing at least one figure of said invention,
describing at least one figure of said invention,
recording said invention,
describing said invention,
drawing said invention,
displaying said invention,
storing said invention,
transmitting said invention,
sharing said invention,
emailing said invention,
filling out at least one application form for said invention,
filing at least one application form for said invention, and
paying at least one application fee, for said invention.

16. The method of claim 14, provided at least one device and at least one software,
said at least one device comprising a monitor, a processor, and a memory,
said at least one software stored in said memory,
said processor coupled to said memory for executing said at least one software,
said processor for processing input from a user,
said processor for displaying said invention on said monitor.
wherein each of said at least one device is selected from the group consisting of:
a mobile phone, a cellular phone, a handheld computer, a handheld electronic device, a portable media player, a wireless device, a tablet computer, a laptop computer, a mobile device, a mobile computer, a desktop or stationary device, a desktop or stationary computer, and a combination of at least two of the above.

17. The method of claim 16, further comprising at least one step selected from the group consisting of:
drawing at least one figure of said invention by using said at least one device,
describing at least one figure of said invention by using said at least one device,
recording said invention by using said at least one device,
describing said invention by using said at least one device,
drawing said invention by using said at least one device,
displaying said invention by using said at least one device,
storing said invention by using said at least one device,
transmitting said invention by using said at least one device,
sharing said invention by using said at least one device,
emailing said invention by using said at least one device,
filling out at least one application form for said invention by using said at least one device,
filing at least one application form for said invention by using said at least one device, and
paying at least one application fee, for said invention by using said at least one device.

18. A method for describing an invention, provided said invention, at least one device, at least one invention-describing formula, and at least one software,
said at least one device comprising a monitor, a processor, and a memory,
said at least one invention-describing formula stored in said memory,
said at least one invention-describing formula for describing said invention,
said at least one software stored in said memory,
said processor coupled to said memory for executing said at least one software,
said processor for processing input from a user,
said processor for displaying said invention and said at least one invention-describing formula on said monitor,
said invention comprising at least one component,
said at least one component is systematized into at least one component system,
each of said at least one component and said at least one component system has a name,
said name comprises a sequential prefix,
a name description,
a reference number, and
a sequential suffix
such that
said sequential prefix and said sequential suffix
match each other and increase sequentially.
the method comprising at least one step selected from the group consisting of:
describing the title of said invention,
describing said sequential prefix,
describing said name description,
describing said reference number,
describing said sequential suffix,
describing what each of said at least one component is,
describing the material of each of said at least one component,
describing the shape of each of said at least one component,
describing the dimension of each of said at least one component,
describing the smell of each of said at least one component,
describing the taste of each of said at least one component,
describing the finish of each of said at least one component,
describing the design of each of said at least one component,
describing the color of each of said at least one component,
describing the sound of each of said at least one component,
describing the property of each of said at least one component,
describing the connection of each of said at least one component,
describing the function of each of said at least one component,
describing the advantage of each of said at least one component,
describing the advantage of said invention,
describing the operation of said invention,
describing the variation of said invention,
describing the ramification of said invention,
describing the variation of each of said at least one component, and
describing the ramification of each of said at least one component.

19. The method of claim 18, further comprising at least one step selected from the group consisting of:
drawing at least one figure of said invention by using said at least one device,
describing at least one figure of said invention by using said at least one device,
displaying said at least one invention-describing formula by using said at least one device,
recording said invention by using said at least one device,
describing said invention by using said at least one device,
drawing said invention by using said at least one device,
displaying said invention by using said at least one device,
storing said invention by using said at least one device,
transmitting said invention by using said at least one device,
sharing said invention by using said at least one device,
emailing said invention by using said at least one device,
filling out at least one application form for said invention by using said at least one device,
filing at least one application form for said invention by using said at least one device, and
paying at least one application fee, for said invention by using said at least one device.

20. The method of claim 18, wherein each of said at least one device is selected from the group consisting of:
a mobile phone, a cellular phone, a handheld computer, a handheld electronic device, a portable media player, a wireless device, a tablet computer, a laptop computer, a mobile device, a mobile computer, a desktop or stationary device, a desktop or stationary computer, and a combination of at least two of the above.
